(19) United States
(12) Patent Application Publication
(10) Pub. No.: US 2013/0228520 A1
(43) Pub. Date: Sep. 5, 2013

(54) POLYMER COATINGS THAT RESIST ADSORPTION OF PROTEINS

(71) Applicants: Douglas L. GIN, Longmont, CO (US); Evan S. Hatakeyama, Hillsboro, OR (US); Christopher J. Gabriel, Louisville, CO (US); Benny Dean Freeman, Austin, TX (US); Hao Ju, Woodbury, MN (US)

(72) Inventors: Douglas L. GIN, Longmont, CO (US); Evan S. Hatakeyama, Hillsboro, OR (US); Christopher J. Gabriel, Louisville, CO (US); Benny Dean Freeman, Austin, TX (US); Hao Ju, Woodbury, MN (US)

(21) Appl. No.: 13/854,769

(22) Filed: Apr. 1, 2013

Related U.S. Application Data
(62) Division of application No. 12/563,717, filed on Sep. 21, 2009, now abandoned.
(60) Provisional application No. 61/098,349, filed on Sep. 19, 2008.

(51) Int. Cl. C02F 1/44

(52) U.S. Cl. CPC C02F 1/444; C02F 1/441
USPC 210/650; 427/244; 210/489

(57) ABSTRACT

The invention provides membranes useful for filtration of water and other liquids. The membrane may be a composite membrane having a polymer layer incorporating quaternary phosphonium or ammonium groups. The polymer layer may be resistant to protein adsorption in an aqueous environment. The membrane may also be a surface-modified membrane in which a polymer having quaternary phosphonium or ammonium groups is covalently attached to the membrane surface. Methods for making and using the membranes of the invention are also provided.

### CROSS REFERENCE TO RELATED APPLICATIONS

This application is a divisional of prior application Ser. No. 12/563,717, filed Sep. 21, 2009 and claims the benefit of U.S. Provisional Application No. 61/098,349, filed Sep. 19, 2008, both of which are hereby incorporated by reference in their entirety to the extent not inconsistent with the disclosure herein.

### STATEMENT REGARDING FEDERALLY SPONSORED RESEARCH OR DEVELOPMENT

This invention was made with government support under grant numbers N00014-05-1-0038 and N00014-02-1-0445 awarded by the Office of Naval Research. The government has certain rights in the invention.

### BACKGROUND OF THE INVENTION

Surfaces that do not adsorb proteins (i.e., “protein-nonadsorbing” or “protein-inert” for brevity) are important in the broad field of biocompatible materials, and in the field of water filtration membranes. Applications of protein-nonadsorbing surfaces in the first area include prostheses, sensors, substrates for enzyme-linked immunosorbent assays, materials for use in contact lenses, and implanted devices (Ratner, 1996). The nonspecific adsorption and accumulation of proteins on the surfaces of these materials can lead to inflammation or an undesired immune response that compromises performance. Newer areas of applications for protein-resistant coatings in biomaterials include systems for patterned cell cultures (Chen, 1997), tissue engineering (Niklason, 1999), materials in microfluidic and analytical roles (Manz, 1998), devices for drug delivery (Santini, 1999; Fu, 2000), and systems for high-throughput screening using proteins (Macbeath, 2000) or cells (Whitney, 1998).

Protein-nonadsorbing surfaces are also important in membrane-based water separation or purification applications involving water feed solutions containing biological or protein-based contaminants. The accumulation of proteins, polysaccharides, nucleic acids, lipids, and other biological macromolecules on the membrane surfaces produced during the biodegradation process (Bouhabila, 2001; Marrot, 2004) encourages the growth of biofilms that effectively reduce flux. This phenomenon leads to a rapid decrease in membrane water flux, operating performance, and lifetime, which mandates regular membrane replacement or cleaning. Such deleterious effects are especially important in the performance of membrane-based water reclamation systems such as membrane bioreactors (MBRs), which purify wastewater using micro-organisms to biologically degrade organic contaminants in the water phase and ultrafiltration (UF) membranes to separate the micro-organisms and resulting solid sludge from the purified water (Bouhabila, 2001; Marrot, 2004; Balomajumder, 2003).

Current methods to mitigate the adsorption and accumulation of proteins and related biofilms on porous membranes include frequent chemical cleaning (Belfort, 1994), back-pulsing (Belfort, 1994), and passing air bubbles near the surface of the membranes to dislodge foulants (Sofia, 2004; Bohabila, 2001; Gander, 2000). However, these procedures have inherent disadvantages for shipboard implementation, such as introducing additional chemicals onto the system, intensifying system maintenance requirements, or requiring a more complex automation and control system for the membranes (Parnham, 1996). Ultimately, when membranes become irreversibly fouled, they must be replaced.

Certain functionalized polymers containing incorporated poly(alkyl ether) (Chen, 1999; Youngblood, 2003), N-halamine (Worley, 2001), or phosphorylcholine groups (Lewis, 2000), have been found to resist the adsorption of marine fouling organisms, microbes, and proteins. These functionalized polymer materials have demonstrated great success in reducing different types of biofouling on surfaces. Polymer coatings based on or containing poly(ethylene oxide) (i.e., PEO) or poly(ethylene glycol) (i.e., PEG) units are known to provide high resistance to nonspecific protein adsorption from water solution (Harris, 1997; Jenney, 1999; Deible, 1998).

However, with the exception of the poly(alkyl ether) groups, these materials are believed to be either not hydrophilic or cost-effective enough to be suitable for water filtration membranes, or sufficiently chemically compatible with conventional polymer water filtration membranes to be useful as protective layers to modify their surface properties. Unfortunately, even the ubiquitous poly(alkyl ether) groups (e.g., PEG and PEO) have chemical stability problems when it comes to using them in protein adsorption resistance applications (Chapman, 2000; Ostuni, 2001). PEO and PEG groups can be auto-oxidized relatively rapidly, especially in the presence of O₂ and transition-metal ions (Crouzet, 1976, Hamburger, 1975; Gerhardt, 1985). Also, the terminal hydroxyl groups of PEO and PEG are oxidized enzymatically in vivo to aldehyde groups (Talarico, 1998; Herold, 1989), allowing cells and other bio-organic contaminants to have a chemical handle for attachment.

Whitesides and co-workers recently identified a number of organic functional groups that afford excellent resistance to nonspecific protein adsorption (Chapman, 2000; Ostuni, 2001). These researchers chemically derivatized self-assembled monolayers (SAMs) on gold surfaces with different organic groups (FIG. 1) and examined how well they resist the adhesion of fibrinogen and lysozyme proteins as a function of time under static exposure test conditions. In general, the chemical groups offering the best protein adsorption resistance were found to be neutral (i.e., non-ionic) groups that are hydrophilic and lack hydrogen-bond donor groups (Chapman, 2000; Ostuni, 2001). In particular, short individual oligo(ethylene oxide) segments, certain oligopeptides, some crown ethers, and certain carbohydrates were found to exhibit the best resistance to fibrinogen and lysozyme adsorption, with ≦5% monolayer area coverage by the proteins after exposure for up to 30 min (FIG. 2) (Chapman, 2000; Ostuni, 2001). A concise mechanistic understanding of how these chemical groups deter protein adsorption on the molecular level is still incomplete (Kane, 2003). However, the empirical evidence provided by these studies nonetheless demonstrates the effectiveness of these functional groups in resisting the nonspecific surface adsorption of proteins. With the exception of the ubiquitous oligo(ethylene oxide) group (i.e., in PEO and PEG materials) mentioned previously, the types of functional groups and chemical trends identified by Whitesides and co-workers are believed to represent current state-of-the-art knowledge in the design of organic coatings for resisting protein adsorption from water (Chapman, 2000; Ostuni, 2001).

A number of possible mechanisms of protein adsorption resistance have been developed based on these and other studies (Kane, 2003: McPherson, 1998; Koehler, 1997; Feldman, 1999; Harder, 1998; Fang, 2005). It has been postulated that minimizing the attractive ionic and hydrophobic interactions between the substrate surface and proteins causes less protein to adsorb (McPherson, 1998; Koehler, 1997). Alternative theories state that strong attractive interactions between the surface and the interfacial water layer play an important role (Feldman, 1999; Harder, 1998). In reality, protein resistance is a much more complicated phenomenon that is also affected by several other factors (Chapman, 2000; Koehler, 1997; Fang, 2005; Blummel, 2007; Kang, 2007; Sethuraman, 2004). Due to the complexity of the problem, research in identifying new protein-resistant chemistries has been mostly empirical.

Protein fouling of membranes in dynamic flow processes is more complex than just static protein adsorption on surfaces. In protein fouling of porous membranes, the dynamic flow of solution across and through the membrane not only causes adsorption of proteins on the membrane surface but also causes them to penetrate and block pores, thereby decreasing the water flux through the membrane (Marshall, 1993; Koehler, 1997; Fane, 1983; Nilsson, 1990; Ognier, 2002). Consequently, both the amount of protein adsorbing to the membrane and the decrease in water flux need to be considered and examined.

Functionalized SAMs, which have been used to empirically identify new protein-resistant chemistries, cannot be used as coatings on traditional polymer-based water filtration membranes because SAMs require a smooth gold (or related inorganic) substrate for adhesion. In general, polymer coatings have been used to reduce protein fouling on membranes because they are compatible with water filtration membranes as well as other surfaces, and can be functionalized to incorporate a variety of chemistries. Several studies have identified PEG-based polymer coatings as protein-resistant materials for water filtration membranes and other surfaces (Zhao, 2007; Chen, 2000; Liu, 2002). The main drawback that limits the usage of PEG-based coatings is their lack of long-term chemical stability (Branch, 2001; Kawai, 2002). PEG-based polymers and related molecules are known to be susceptible to oxidation and degradation by some biological entities (Branch, 2001; Kawai, 2002). Examination of new chemistries for incorporation into polymer-based protein-resistant coatings is necessary to address the problem of protein fouling in membranes.

Polymers containing cationic quaternary phosphonium and related functional groups have been used as (1) water-compatible polymer binders for biocide-release coatings that mitigate the adhesion of biological organisms (barnacles, algae, etc.) (Linder, 1992; Linder 1994), (2) polymer photosensitizers for lithographic processes (Okochi, 1995; Udenfreind, 1972), and (3) antimicrobial, biocidal, or antibacterial polymers for coatings (Pindzola, 2003; Zhou, 2007; Mehta, 2005; Price, 2005; Garmin, 2005; Fleming, 2000, Nishikubo, 1989; Russell, 2006; Kristiansen, 2006; Kenawy, 2006 a; Kenawy; 2006 b; Popa, 2004; Popa, 2003 a; Popa, 2003b; Schroeder, 2002). In the latter biocidal and antimicrobial applications, the phosphonium polymers' mode of action is to be toxic to certain living organisms by interrupting or interfering with certain biological processes.

In addition, several references describe membranes which include quaternary ammonium functional groups. U.S. Pat. No. 5,178,766 to Ikeda et al. describes composite semipermeable membranes having high rejection of electrolytes which employ an ultra-thin membrane having a covalently bonded quaternary nitrogen atom. The English abstract of Japanese Publication No. 63-151303 describes cation charge type composite reverse osmosis membranes made by coating a support membrane with an ultra-thin membrane based on a polymer having a quaternary nitrogen atom. The English abstract of Japanese Publication No. 2002-355553 describes an endotoxin removing membrane made by coating a porous membrane with a polymer having a quaternary ammonium salt.

It is believed that polymers containing quaternary phosphonium and related functional groups have not been previously identified as imparting resistance to protein adsorption. The alkyltrimethylammonium chloride group has been previously tested in static protein adsorption studies as a substituent attached to a SAM, and shown to have mediocre results (Otsuni, 2001). However, polymers containing this particular functional group have not been tested for protein-adsorption resistance, to our knowledge. It is believed that quaternary phosphonium and other related Group VB functional groups have not been explored at all for their ability to resist the nonspecific adsorption of proteins in any format (SAM, polymer, or otherwise). It should be noted that protein adsorption on surfaces is a very different phenomenon than general “biofouling” by marine organisms (i.e., barnacles, algae, etc.). The latter phenomenon involves the adhesion and accumulation of living organisms on surfaces, whereas the former phenomenon involves adsorption by non-living biological macromolecules. Consequently the mechanisms by which these two sets of substrates adhere to a surface are very different and so are the approaches to prevent them from doing so. For example, one approach that has been widely used to prevent the buildup of marine organisms such as barnacles on ship hulls is the use of coating materials that slowly release toxic or biocidal substances such as organotin compounds (Baccante, 1997). Although effective, this approach has major environmental consequences and is not suitable for water reclamation. Other approaches include the design of polymer materials with fluorinated components for low adhesion properties (Linder, 1992; Linder, 1994), or polymers with electrical conducting properties so that electrical currents can be applied to deter organisms from adhering (Okochi, 1995). In contrast, the development of polymers that intrinsically resist protein adsorption has concentrated mainly on designing polymers with specific chemical functional groups that have been empirically found to resist protein adhesion (i.e., surface chemistry tailoring) (Chapman, 2000; Ostuni, 2001).

There remains a need for improved coatings which are resistant to protein adsorption, in particular coatings which have an intrinsic ability to resist protein adsorption in an aqueous environment and are suitable for use in water filtration.

### SUMMARY OF THE INVENTION

In one aspect, the invention provides composite membranes comprising a polymer layer incorporating quaternary phosphonium or ammonium groups. In another aspect, the invention provides surface-modified membranes in which quaternary phosphonium or ammonium groups are covalently attached to the membrane surface. The membranes of the invention may be used for water filtration and may assume a variety of forms including plane, tubular, and spiral configurations.

In an embodiment of the invention, polymeric coatings incorporating positively charged quaternary phosphonium and related organic functional groups are used to impart resistance to adsorption and surface accumulation of proteins dissolved or suspended in water or aqueous solutions. Related organic functional groups include, but are not limited to, quaternary ammonium groups. The protein-resistant functional groups used in the present invention can be readily synthesized, are water-compatible, and can be chemically stable with respect to hydrolysis, acid attack, base attack, oxidation, and reduction. Polymer coatings formed from monomers functionalized with these groups can exhibit protein-adsorption resistance properties on par with, or better than, polymers containing the oligo(alkyl ether) group (i.e., PEO and PEG) which is the current benchmark functional group for protein-resistant coatings.

In an embodiment, the surface to be treated is the surface of a porous membrane, in which case a composite membrane may be formed by the combination of a dense or nonporous polymer layer and the underlying porous support membrane. In an embodiment, the invention provides a composite membrane comprising a porous support and a dense polymeric layer attached to the support, the polymeric layer comprising a cross-linked polymer comprising quaternary phosphonium or ammonium groups. In another embodiment, the composite membrane may comprise a support membrane having a layer which is effectively nonporous and a dense polymeric layer of the invention. In an embodiment, the dense polymer layer applied to the support is not covalently attached to the support.

In an embodiment, the polymeric layer is formed by polymerization of a monomer having the formula:

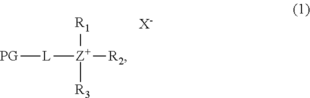

wherein PG is a polymerizable group,
L is a linking unit which is an alkyl group having from 1 to 8 carbon atoms or —(CH₂ CH₂O)ₙ—CH₂CH₂— where n is from 1 to 4,
Z is nitrogen or phosphorus,
R₁, R₂ and R₃, independently from one another, are optionally substituted straight-chain or branched-chain hydrocarbons having 1-8 carbon atoms, and
X⁻ is an anion.

In another aspect, the invention provides a method for treating a surface in which positively charged quaternary phosphonium or related organic functional groups are covalently attached to the surface. The surface treatment method may form a polymer covalently attached to the membrane surface, the polymer containing the quaternary functional groups. The polymer may be in the form of grafts or brushes. The surface to be treated may be the surface of a porous membrane or a membrane incorporating a nonporous layer. The invention also provides such surface-treated membranes.

In another embodiment, the invention also provides methods for improving the water permeation stability of a membrane by coating a surface of the membrane with a nonporous hydrophilic polymeric layer incorporating positively charged quaternary phosphonium and related organic functional groups or by covalently attaching such groups to the surface of the membrane. In another embodiment, the invention provides methods for increasing the protein rejection of a membrane, by coating the surface of the membrane with a nonporous hydrophilic polymeric layer incorporating positively charged quaternary phosphonium and related organic functional groups or by covalently attaching such groups to the surface of the membrane.

In an embodiment, the invention provides a method for filtering an aqueous solution comprising the steps of: bringing the aqueous solution into contact with a first side of the surface-coated or surface-modified membrane, the first side including surface quaternary phosphonium or ammonium groups; applying a pressure difference across the membrane; and withdrawing filtrate from a second side of the membrane. The aqueous solution may be water containing impurities. In another embodiment, the invention provides a method for purifying water comprising the steps of: bringing water containing impurities into contact with a first side of the surface-coated or surface-modified membrane, the first side including surface quaternary phosphonium or ammonium groups; applying a pressure difference across the membrane; and withdrawing purified water from a second side of the membrane. The invention also provides methods for filtering other liquids by passing them through the membranes of the invention. A variety of aqueous solutions may be filtered using the methods of the invention. The solution may be a saline or nonsaline solution. Saline solutions include seawater, brackish water, and industrial waste water.

### BRIEF DESCRIPTION OF THE DRAWINGS

FIG. 1: Chemical derivatization of SAMs on gold surfaces with different organic functional groups (FGs).

FIG. 2: Functional groups found to have good resistance to the nonspecific adsorption of proteins from solution when attached to the SAMs shown in FIG. 1.

FIG. 3: General structures of quaternary phosphonium-functionalized polymers for protein-adsorption-resistant coating materials.

FIG. 4: Structures of specific and general functional quaternary monomers.

FIG. 5a: Chemical structures of the functional monomers used in Example 1 and their corresponding polymers.

FIG. 5b: Illustration of a synthesis scheme for styrene-based quaternary ammonium or phosphonium monomers.

FIG. 6: SEM cross-sectional photograph of a PSf membrane coated with poly(6a) of Example 1.

FIG. 7: Schematic of the fluorescence-based, adsorption/quantitative desorption static protein assay method described in Example 1.

FIG. 8: Static protein adsorption on polymer-coated membranes containing protein resistant functional groups identified in prior SAM studies (a) BSA adsorption, and (b) Fg adsorption. Values shown are the averages of three independent sample runs, with standard deviation error bars.

FIG. 9: Static protein adsorption on phosphonium-based polymer-coated membranes (a) BSA adsorption, and (b) Fg adsorption. Values shown are the averages of three independent sample runs, with standard deviation error bars.

FIG. 10: Static protein adsorption on ammonium-based polymer-coated membranes (a) BSA adsorption, and (b) Fg adsorption. Values shown are the averages of three independent sample runs, with standard deviation error bars.

FIG. 11: Plot of relative permeance vs. time during the filtration of a 1 g/L: BSA solution for uncoated PSF, and PSf membranes coated separately with poly(1b), poly(2), and poly(3).

FIG. 12: Plot showing relative permeance vs. time during the filtration of a 1-g/L BSA solution for uncoated PSf and PSf membranes coated separately with phosphonium and ammonium-based polymers.

FIG. 13: Comparision of the static BSA adsorption levels of poly(1b), an amorphous hydrophilic PEG-based polymer coating; poly(n-butyl acrylate) an amorphous hydrophobic control coating; poly(5a), an amorphous phosphonium-based polymer coating; and poly(7), a nanostructured LLC polymer analogue of poly (5a). Values shown are the averages of three independent sample runs, with standard deviation error bars.

FIG. 14: Performance of uncoated PSf vs. cross-linked 80 wt. % PEGDA (n=14)-coated PSf membrane in dead-end BSA (1 g/L) filtration studies: (a) relative flux change (J/Jₒ) as a function of time; and (b) percent protein rejection as a function of time.

FIG. 15: Performance of poly(styrenemethylenetrimethylphosphonium bromide)-coated PSf membrane vs. uncoated PSf in dead-end BSA (1 g/L) flow studies (a) relative water flux as a function of time; and (b) percent protein rejection as a function of time.

FIG. 16: Selectivity vs. permeability plot for PSf composite membranes prepared with monomers developed in this research program and other commercial membranes. BSA was used as the model protein

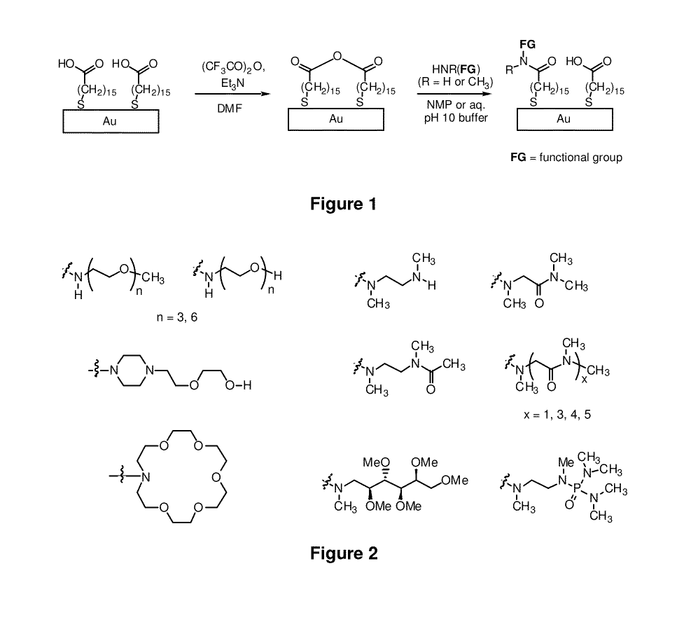

### DETAILED DESCRIPTION

As used herein, a “membrane” is a barrier separating two fluids that allows transport between the fluids. A “fluid” may be a liquid or a gas. In an embodiment, an aqueous solution is transported through the membranes of the invention, which requires that the membranes be permeable to the aqueous solution. In an embodiment, the membrane is permeable to an aqueous solution when a pressure difference of 2 MPa or less is applied across the membrane. In other embodiments, the membrane is permeable to the aqueous solution when a pressure difference of 1.5 MPa or less, 1 MPa or less, 0.5 MPa or less, or 0.25 MPa or less is applied across the membrane.

In one aspect, the invention provides a composite membrane comprising a support membrane and a dense or non-porous polymeric layer attached to the support. The term “dense” film or “dense” as used herein, means a polymer structure which is substantially free from pores and micropores, especially from micropores of diameter greater than or equal to 10 Angstroms. The support membrane will typically include first and second opposing surfaces, such as the top and bottom of the support. In use, fluid will flow from one surface (side) of the membrane through the substrate to the second surface (side), exiting the second surface. The polymer layer is typically attached to one of these membrane surfaces, so that fluid enters the membrane through the polymer layer. If the support membrane is asymmetric, the polymer layer will typically be formed on the selective layer of the support membrane.

The support may be porous or may comprise a non-porous layer (in which case the support may be considered to be effectively dense/nonporous as in the case of commercial reverse osmosis membranes). In different embodiments, the support may be a reverse osmosis membrane, a nanofiltration membrane, an ultrafiltration membrane or a microfiltration membrane. A nanofiltration membrane contains nanometer sized pores. In an embodiment, a nanofiltration membrane can reject solutes 1-10 nm in size. “Ultraporous” signifies a pore size between about 2.5 and about 120 nm and an “ultrafiltration membrane” has an effective pore size between about 2.5 and about 120 nm. “Microporous” signifies a pore size between about 45 nm and about 2500 nm and a “microfiltration membrane” has an effective pore size between about 45 nm and about 2500 nm. The support itself may be a composite membrane. When the support is porous, the nonporous layer may be primarily formed on the outer surface of the membrane rather than the inner pore surfaces.

The porous support may be made of any suitable material known to those skilled in the art including polymers, metals, and ceramics. In various embodiments, the porous support is a polyethylene (including high molecular weight and ultra high molecular weight polyethylene), polyacrylonitrile (PAN), polyacrylonitrile-co-polyacrylate, polyacrylonitrile-co-methylacrylate, polysulfone (PSf), Nylon 6, 6, poly(vinylidene difluoride), or polycarbonate support. The support may also be an inorganic support such as a nanoporous alumina disc (Anopore Whatman, Ann Arbor, Mich.). The porous support may also be a composite membrane.

The porous support is selected to be compatible with the solution used for formation of the polymeric layer, as well as to be compatible with the liquid or gas to be filtered. The porous support can be hydrophobic or hydrophilic.

In the practice of the invention, the polymeric coating applied to the support membrane incorporates positively charged quaternary phosphonium and related organic functional groups. In an embodiment, the polymeric coating incorporates quaternary phosphonium or ammonium groups. At least some of the quaternary phosphonium or ammonium groups are located at the surface of the polymeric coating. In an embodiment, the density of surface functional groups is sufficient to cause a reduction in protein adsorption relative to the uncoated surface. In an embodiment, the solubility of the as-formed coating in water or aqueous solution to be filtered is negligible.

In an embodiment, the polymeric layer is hydrophilic. As used herein, a hydrophilic polymeric layer is wettable by water and capable of spontaneously absorbing water. The hydrophilic nature of the layer can be measured by various methods known to those skilled in the art, including measurement of the contact angle of a drop of water placed on the membrane surface, the water absorbency (weight of water absorbed relative to the total weight, U.S. Pat. No. 4,720,343) and the wicking speed (U.S. Pat. No. 7,125,493). The observed macroscopic contact angle of a drop of water placed on the surface of the polymeric layer may change with time. In different embodiments, the contact angle of a 1 or 2 μL drop of water placed on the support surface (measured within 30 seconds) is less than 90 degrees, from 5 degrees to 85 degrees, or from zero degrees to 45 degrees. In another embodiment, the polymeric layer is fully wetted by water and water soaks all the way through the layer after about one minute.

In an embodiment, the polymeric layer is amorphous. In another embodiment, the polymeric layer may be ordered to enhance or modulate protein-resistance properties.

The polymeric layer may be cross-linked. In an embodiment, the embodiment, the polymeric layer contains chemical cross-links. The extent of crosslinking can be influenced by the relative amounts of crosslinker and monofunctional monomer. In an embodiment, the amount of crosslinker is from 0.01 to 10 mol % or from 0.01 to 5 mol % based on the total amount of monomer. In an embodiment, the amount of cross-linking is selected to provide sufficient permeability across the layer while providing sufficient layer strength to withstand the filtration process.

When the polymeric layer is to be used as a separating layer, the layer is sufficiently thin to provide the desired permeability. In different embodiments, the thickness of the polymeric layer is from 0.01 μm to 10 μm, from 0.01 μm to 5 μm, or from 0.01 μm to 2 μm, from 0.2 to 1.5 μm, or from 0.2 to 1 μm. In an embodiment, the composite membrane has a volumetric flux for pure water of 150 L/(m² h atm) for a pressure drop between 0.7 and 2 atm.

In an embodiment, the polymeric layer is formed by polymerization of a polymer precursor having quaternary phosphonium or ammonium groups. As used herein, a “polymer precursor” means a molecule or a portion thereof which can be polymerized to form a polymer or copolymer. Such precursors include monomers and oligomers. A cross-linked polymeric layer may be formed by polymerization of a polymeric precursor in the presence of cross-linking agent.

In an embodiment, the polymeric layer is formed by forming a precursor layer of a mixture comprising polymerizable functionalized monomers of the invention and a solvent, then polymerizing the monomers. In an embodiment, the monomers are also cross-linked during the polymerization process. In an embodiment, polymerization occurs through photopolymerization or thermally initiated polymerization. In an embodiment, radical polymerization is preferred because this method is tolerant of water and a wide range of chemical functional groups. However, other polymerization methods may be employed. The process of layer formation may be repeated to build up the desired membrane thickness.

In an embodiment, the solution or mixture comprises a plurality of polymerizable functionalized monomers, a solvent, and a polymerization initiator. In another embodiment, the mixture comprises a plurality of polymerizable functionalized monomers, a solvent, a polymerization initiator, and a cross-linking agent. In an embodiment, the structural units of the polymer layer only come from the functionalized monomers and the cross-linking agent. A number of cross-linking agents are known to the art. Common crosslinking agents include, but are not limited to, divinylbenzene (DVB), ethylene glycol di(meth)acrylate and derivatives thereof, and methylenebisacrylamide and derivatives thereof. In another embodiment, a non-functionalized co-monomer (in addition to the cross-linking agent) can also be included in the mixture and used to form the cross-linked film. Inclusion of non-functionalized monomers and cross-linking agents in combination with the functional monomers can reduce expense and/or provide mechanical property tuning of the resulting functional coating. In different embodiments, the amount of functional monomer is greater than 25 mol %, 50 mol %, 75 mol %, or 90 mol % (of the total amount of monomers). In an embodiment, the casting solution includes from 1-15 wt % monomer, 0.1-1 wt % photoinitiator, and 1-5 mol % cross-linker, balance solvent.

The solvent may be any low boiling point solvent that dissolves the monomer. A mixture of one or more solvents may also be used. Useful solvents include, but are not limited to, methanol. In an embodiment, the organic solvent used in the solution and the support are selected to be compatible so that the support is substantially resistant to swelling and degradation by the organic solvent.

The precursor layer may be formed by any method known to the art, including but not limited, to roll casting and spray casting. Solvent may be evaporated from the precursor layer prior to polymerization, either at ambient or elevated temperature.

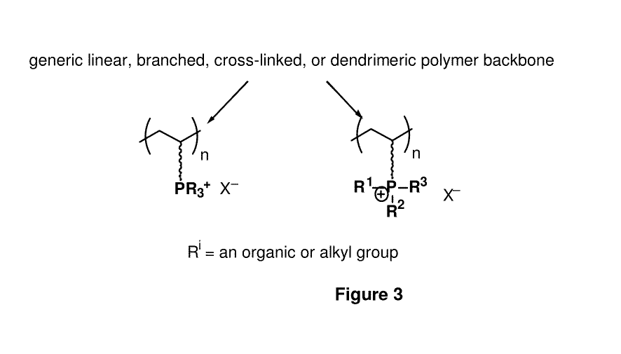

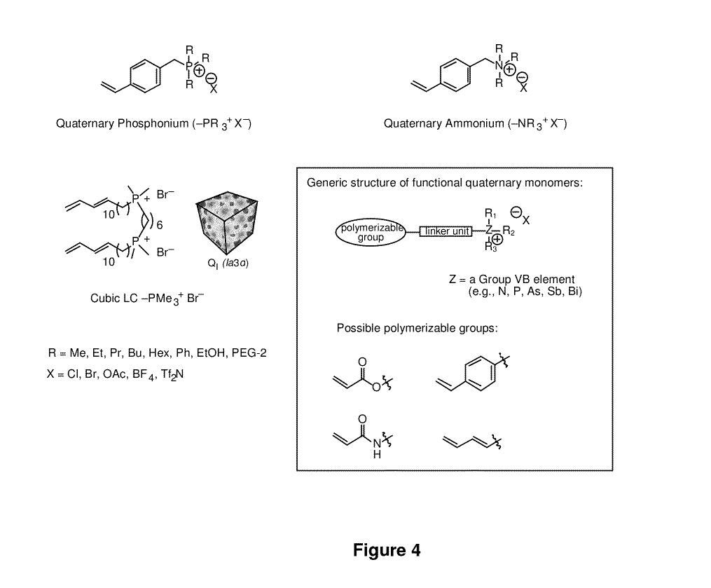

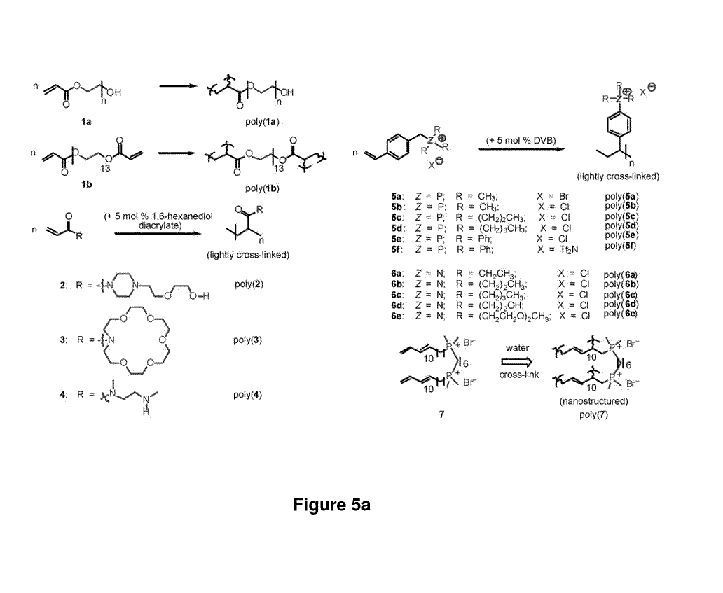

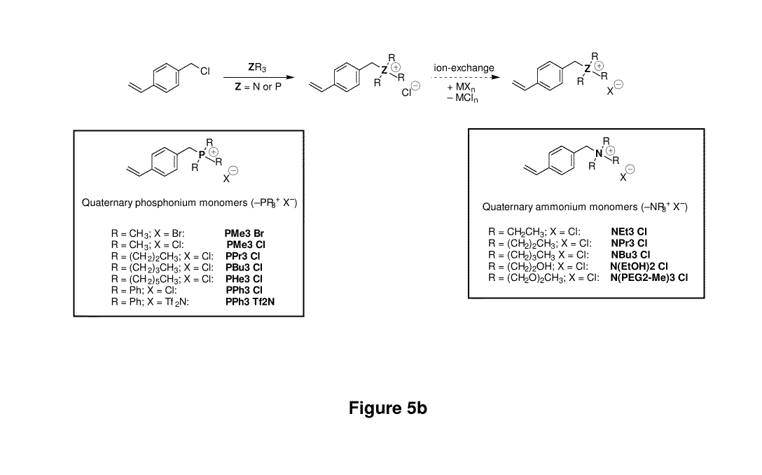

A single species of functionalized monomer may be used, but a plurality of monomers is required to form the polymeric layer. In an embodiment, the functionalized monomer can be described by the generic structure shown in Formula (I) or the inset of FIG. 4 in which the crucial functional atom in the quaternary group is given the generic label “Z”. In this structure, the quaternary Z-based group is connected to a polymerizable group (PG) though a linker unit (L). Gemini monomers, in which two Z atoms are linked together by a spacer group, as illustrated in FIG. 4, can also be suitable for use with the invention. FIGS. 5a and 5b also provide several specific examples of quaternary monomers in which the quaternary ammonium or phosphonium group is part of the monomer backbone. FIG. 3 illustrates some general structures in which quaternary phosphonium groups are attached to a generic polymer backbone, which can be linear, branched, cross-linked, or dendrimeric. The functional groups can be directly connected to the polymer backbone or attached via a non-functional or functional spacer between the backbone and the functional group. The functionalized monomer may be a polymerizable surfactant having a hydrophilic headgroup and a hydrophobic tail group (the polymerizable group plus the tail group).

The functional atom Z is an element from IUPAC Group 15 of the periodic table. IUPAC Group 15 can also be referred to as the “nitrogen group”, as Group VA, or as Group VB, depending on the nomenclature system. Members of this group include nitrogen, phosphorus, arsenic, antimony, and bismuth. In an embodiment, Z is selected from the group consisting of nitrogen and phosphorus. In an embodiment, Z is phosphorus and the monomer is a quaternary phosphonium monomer. In another embodiment, Z is nitrogen and the monomer is a quaternary ammonium monomer.

In one aspect of the invention, R₁-R₃ are organic or alkyl groups. In an embodiment, R₁, R₂ and R₃ are individually selected from optionally substituted alkyl groups. In an embodiment, optionally substituted alkyl groups include unsubstituted or substituted straight- or branched-chain hydrocarbon groups having 1-8 carbon atoms. Exemplary unsubstituted alkyl groups include methyl, ethyl, propyl, isopropyl, n-butyl, t-butyl, isobutyl, pentyl, hexyl, and the like. Substituted alkyl groups include, but are not limited to, alkyl groups substituted by one or more of the following groups: cycloalkyl, hydroxy, alkoxy, alkyloxyalkoxy, and the like. In an embodiment, R₁, R₂, or R₃ may be based on an alcohol (for example, EtOH), PEG (for example, PEG-2), or any similar organic group functionalized with a heteroatom other than oxygen. In another embodiment, R₁, R₂, and R₃ may be alkenyl, alkynyl or an aryl group having from 1 to 8 carbon atoms. In an embodiment, R₁, R₂, and R₃ are the same.

In the structures shown in FIGS. 3 and 4, X⁻ is an anion. In an embodiment X⁻ is an anion capable of forming a salt with a quaternary ammonium or phosphonium group. In an embodiment, X⁻ is selected from the group consisting of Br⁻, BF₄, Cl⁻, Tf₂N⁻ and OAc. In an embodiment, the anion X⁻ is selected from the group consisting of Cl⁻, Br⁻, or I⁻ or the group consisting of Br⁻ and Cl⁻. In an embodiment, X is not the anion residue of an acid having an aliphatic, aromatic or alkaryl hydrocarbon group comprising at least 5 carbon atoms.

Suitable polymerizable groups include, but are not limited to, the polymerizable groups shown in the inset of FIG. 4 (acrylate, styrene, acrylamide, or diene group). In an embodiment, suitable polymerizable groups include acrylate, methacrylate, diene, vinyl, (halovinyl), styrenes, vinylether, hydroxy groups, epoxy or other oxiranes (halooxirane), dienoyls, diacetylenes, styrenes, terminal olefins, isocyanides, acrylamides, and cinamoyl groups.

In an embodiment, the linking unit is an alkyl group having from 1 to 8 carbon atoms. Longer linking units may be difficult to obtain and/or may be too hydrophobic for water filtration throughput. In another embodiment, the linking unit may be alkenyl, alkynyl or an aryl group having from 1 to 8 carbon atoms. The linking unit can also be a functional linker such as a PEG linker or a chemical group that is not entirely C and H-based for ease of modular synthesis. In an embodiment, the linking unit does not include silicon. The linker may be polar or nonpolar.

In an embodiment, the monomer is selected from the set of quaternary phosphonium monomers and quaternary ammonium monomers listed in FIG. 5a or 5b. In an embodiment, R₁, R₂ and R₃, independently from one another, are selected from the group consisting of methyl and ethyl.

In an embodiment, the quaternary phosphonium or ammonium groups of the polymer layer may be described by the formula

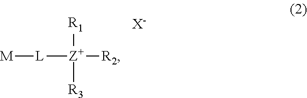

Where Z, L, R₁-R₃ and X⁻ are as defined above and M is a structural repeating unit of the polymer layer. For the monomers described by Formula 1, M is a structural repeating unit of the polymer backbone which results from the polymerization of PG. When a combination of monomers with different polymerizable groups are used, there may be a plurality of structural repeating units (M₁, M₂, M₃ . . . ). In an embodiment, Z⁺ is N⁺ or P⁺, R₁, R₂ and R₃, independently from one another, are optionally substituted straight-chain or branched-chain hydrocarbons having 1-8 carbon atoms, and X⁻ is an anion, L is a linking unit which is an alkyl group having from 1 to 8 carbon atoms or —(CH₂CH₂O)ₙ—CH₂CH₂— where n is from 1 to 4. In another embodiment, R₁, R₂ and R₃, independently from one another, are selected from the group consisting of methyl, ethyl, propyl, isopropyl, n-butyl, t-butyl, isobutyl, pentyl, hexyl groups, —(CH₂)ₙ—OH where n is from 1 to 5, —(CH₂—CH₂O)ₙ—CH₃ where n is 1 is from 2, and —(CH₂—CH₂O)ₙ—H where n is from 1 to 2. In an embodiment, the anion X⁻ is selected from the group consisting of Cl⁻, Br⁻, or I⁻.

In an embodiment, the quaternary ammonium or phosphonium groups are pendant groups. As used herein, a pendant group is covalently bound to the polymer backbone, but do not form part of the polymer backbone.

In an embodiment, the polymer layer does not further comprise acid functional groups such as carboxyl or sulfonic groups. In different embodiments, the polymer layer is not a cross-linked polyamide layer having quaternary nitrogen atoms in its side chains, not a polyethylene imine layer having pendant quaternary ammonium or phosphonium groups, or not a polyamine or polyalkyleneamine having pendant quaternary ammonium or phosphonium groups. In another embodiment, the polymer layer does not comprise a diallyamine copolymer having pendant quaternary ammonium or phosphonium groups.

Suitable solvents include, but are not limited to, liquids which provide suitable solubility for the monomer(s) and which can be readily evaporated or removed. In an embodiment, the solvent is compatible with an underlying support membrane. In an embodiment, the solvent is polar. In an embodiment, the solvent is an alcohol. In an embodiment where the monomer is capable of forming a lyotropic liquid crystal phase, the combination of the solvent and the processing conditions are selected so that the monomer does not retain the lyotropic liquid crystal phase during polymerization. This allows formation of a dense, rather than a porous, polymeric film.

The polymerization initiator can be photolytically or thermally activated. Suitable polymerization initiators are known to those skilled in the art.

In another aspect, the invention provides surface-treated membranes in which positively charged quaternary phosphonium or related organic functional groups are covalently attached to the membrane surface. In an embodiment, quaternary phosphonium or ammonium groups are covalently attached to the membrane surface.

Compounds for graft polymerization on polymer membrane substrates include, but are not limited to compounds according to formula 1 where PG is a polymerizable group, L is a linking unit which is an alkyl group having from 1 to 8 carbon atoms, and aryl group or —(CH₂CH₂O)ₙ—CH₂CH₂— where n is from 1 to 4, and combinations thereof; Z is nitrogen or phosphorus, R₁, R₂ and R₃, independently from one another, are optionally substituted straight-chain or branched-chain hydrocarbons having 1-8 carbon atoms, and X⁻ is an anion.

In an embodiment, PG is a styrene group or an acrylamide group and X is Cl⁻, Br⁻, or I⁻. Suitable polymeric membrane materials include, but are not limited to, polyethylene (PE), polypropylene (PP), poly(vinylidene fluoride) (PVDF), polysulfone (PSf), and polyethersulfone (PES). In an embodiment, the membrane material is other than polyacrylonitrile.

A variety of techniques for grafting of molecules onto polymer surfaces are known to the art. Both “grafting from” and “grafting to” techniques have been described. In an embodiment, a “grafting from” technique is used in which active species on the polymer surfaces initiate polymerization of the monomers from the surface toward the bulk phase. “Grafting from” methods known to the art include, but are not limited to, plasma discharge methods, UV irradiation methods, and ozone methods.

As regards UV irradiation methods, the method of choice depends in part on the substrate material. For example, some membrane materials have been shown to be light sensitive in the UV range and do not need an initiating agent for radical production. These membranes include PSf and PES (Taniguchi, 2004). For such membranes the membranes can be surface-treated by contacting the membrane with a monomer solution followed by exposure to UV light. For membranes which are not light sensitive in the UV range, a photoinitiator can be added to the monomer solution.

Another known UV irradiation technique relies on formation of surface-bound initiator moieties on the polymer surface prior to contact of the surface with the monomer solution. Ma et al. have demonstrated a photoinduced living graft polymerization process in which acrylic acid was grafted to polypropylene membranes (Ma, 2000). In an embodiment, membrane surface modification may be performed as follows: soak membrane in benzene solution with benzophenone (BP), irradiate with UV light (in a reduced oxygen “O₂ free” environment), wash membrane with acetone and completely dry membrane, soak membrane in benzene solution with ammonium or phosphonium monomer, irradiate with UV light (under an “O₂ free” environment). Polymer grafts/brushes containing the ammonium or phosphonium chemistry are expected to form which are chemically bound to the surface of the membrane.

In an embodiment, the water permeation stability of a membrane is increased by application of the surface coating of functionalized polymeric material or surface modification of the membrane with quaternary functional groups according to the invention. When the membrane is exposed to an aqueous solution comprising proteins, the water permeation stability may be assessed by the relative change in water flux performance as a function of time. In an embodiment, the water permeation stability may be assessed by plotting the ratio of the water flux to the initial flux for pure water (J/Jₒ) as a function of time. In an embodiment, the value of J/Jₒ does not change by more than 30% over two hours.

In an embodiment, the protein rejection of a membrane is increased by application of a surface coating of functionalized polymeric material or by surface modification of the membrane according to the invention. In different embodiments, the protein rejection is greater than or equal to 95%, 96%, 97%, 98% or 99% for the surface-coated membranes of the invention.

In an embodiment, the invention provides methods for treating a surface in order to improve its resistance to protein adsorption. In an embodiment, the surface is at least partially coated with a dense or non-porous layer of polymeric material, the polymeric material comprising quaternary phosphonium or related functional groups. In other embodiments the invention provides devices which have been surface coated with a nonporous layer of this polymeric material. In an embodiment, the protein binding capacity is less than 2, 3, 4 or 5 mg/m² for BSA or less than 5, 7.5, 10, 12.5 or 15 mg/m² for FSA (for exposure to 1 g/L protein solutions). In another embodiment, the protein binding capacity of the membrane is less than 25 mg/ml, less than 20 mg/ml, or less than 15 mg/ml.

In another aspect, the invention provides a method for purifying water comprising the comprising the steps of: bringing water containing impurities into contact with the a first side of the surface-coated or surface-modified membrane, the first side including surface quaternary phosphonium or ammonium groups; applying a pressure difference across the membrane; and withdrawing purified water from a second side of the membrane. The water may be purified through removal of fine particles and/or organic materials or by removal of salts.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

In general, the terms and phrases used herein have their art-recognized meaning, which can be found by reference to standard texts, journal references and contexts known to those skilled in the art. Any preceding definitions are provided to clarify their specific use in the context of the invention.

The invention may be further understood by the following non-limiting examples.

### Example 1

Herein, we show that several simple quaternary phosphonium- and ammonium-based polymers (FIG. 5a) are effective coatings for commercial water filtration membranes that resist protein adsorption under static exposure and dynamic flow conditions. Phosphonium- and ammonium-functionalized polymers have previously been used as biocides to remove bacteria and living organisms from surfaces (Popa, 2004; Kanazawa, 1993b); however, to our knowledge they have not been studied for resisting non-specific protein adsorption. Only one example of a tetra(alkyl)ammonium-functionalized SAM has been previously explored for protein resistance and exhibited only mediocre results (Otsuni, 2001). When presented as coatings on a commercial ultrafiltration (UF) polysulfone (PSf) membrane support, these cationic phosphonium and ammonium polymers resist non-specific protein adsorption as good as, or better than, cross-linked PEG-acrylate-based coatings.

It was also found that the some of the best protein-resistant groups identified in prior SAM studies did not perform as well under static protein exposure conditions when presented as polymer coatings. Initial dynamic flow membrane fouling experiments on these functionalized polymers showed different trends in protein adsorption when compared to the static exposure experiments and prior SAM studies in the literature. Collectively, these results suggest that differences in coating surface environment (i.e., surface structure and substrate nature), and experimental test conditions (i.e., static exposure vs. dynamic flow) can greatly affect protein adsorption results. In addition, preliminary evidence also showed that polymer surface morphology and nanostructure with these functional groups are important factors that can affect overall protein anti-fouling performance.

### Experimental Section

### Materials and General Procedures.

All chemical syntheses were carried out under a dry argon atmosphere using standard Schlenk line techniques, unless otherwise noted. Poly(ethylene glycol) acrylate (Mₙ approximately 480) and poly(ethylene glycol) diacrylate (PEGDA) (M.W.=743, n=13) were used as purchased. Preparation of membrane coating solutions and membrane coating procedures were all performed in the air, unless otherwise noted. All reagents and solvents were purchased from the Sigma-Aldrich Chemical Company or Fisher Scientific in ACS Reagent Grade or higher purity, and used as received unless otherwise noted. PSF ultrafiltration (UF) membranes (Type A-1) were kindly provided by General Electric (Fairfield, Conn.). The PSF membranes were supplied on non-woven fabric supports approximately 50 μm thick. Solupor E075-9H01A membrane support films (ca. 35 μm thick) were obtained from DSM Solutech (Geleen, The Netherlands). Ultra-pure water was produced by a Milli-Q water purification system. Chromatographic separations were performed on silica gel 60 (230-400 mesh, 60 Å) using the indicated solvents.

BSA (further purified fraction V, CAS #9048-46-8) and Fg (fraction I, type I-S: from bovine plasma, CAS#9001-23-5) were used as model proteins for the static and dynamic fouling experiments. BSA was chosen because of its extensive use as a model protein in other membrane protein fouling experiments (Nakanishi, 2009; Marshall, 1993). Fg was chosen because of its use in several SAM-based protein-anti-fouling studies (Ostuni, 2001; Fedlman, 1999; Harder, 1998; Sethuraman, 2004). Both are common blood proteins and have similar isoelectric points (p/) of about 5.5. However they differ greatly in size and molecular weight (74 and 340 kDA, respectively).

### Instrumentation.

¹H NMR spectra were recorded at 400 or 500 MHz and ¹³C NMR spectra at 100 or 125 MHz on a Varian Inova 400 or 500 instrument as indicated. NMR Chemical shifts are reported in ppm relative to residual non-deuterated solvent. UV-visible absorption spectra were obtained at (21±1)° C. using an Agilent 8453 spectrophotometer or a Shimadzu Biospec-mini spectrophotometer. Fourier-transform infrared (FT-IR) spectra were recorded using a Mattson Satellite FT-IR spectrometer. The FT-IR samples were prepared as thin films on Ge crystals. Mass spectral analysis was performed at the Dept. of Chemistry & Biochemistry Mass Spectrometry Facility at the University of Colorado at Boulder. Powder X-ray diffraction (XRD) analysis of nanostructured polymer coatings was performed using an Inel CPS 120 diffraction system (Cu K_{α} radiation). Roll-casting of monomer solutions to evenly spread the monomers onto clean PSf membranes was performed using a custom-made roll-casting apparatus using a Gardco wire-wound rod (rod #0), or an automatic draw-down machine (Gardco, Model DP-8201, Pompano, Fla.). The custom-made roll-casting apparatus used a system of weights to keep a constant rod pressure and draw speed to ensure even and reproducible coatings. Photopolymerizations were conducted using either a Spectroline XX-15A 365 nm UV lamp (8.5 mW cm⁻² at the sample surface) for the coated samples prepared for the static protein adsorption studies, or Fisher Scientific 312 nm UV chamber FB-UVXL-1000 (3.0 mW cm⁻² at the sample surface) for the coated samples prepared for the protein fouling studies performed under dynamic conditions. UV light fluxes at the sample surface were measured using a Spectroline DRC-100× digital radiometer equipped with a DIX-365 UV-A sensor. Photopolymerizations for the static protein adsorption studies were conducted in a custom-made, vacuumable photopolymerization chamber with an aluminum base, and a Pyrex glass plate cover. Static protein exposure studies were performed using 25-mm I.D. stirred dead-end filtration cells (Advantec MFS model UHP-25) in a non-flowing configuration by placing the protein solution in the top feed reservoir and allowing it to contact the top of the membrane for a specific amount of time, without permeation through the membrane. Protein fouling and separation performance testing of the membranes under dynamic flow was performed using 76-mm I.D. stirred dead-end filtration cells (Advantec MFS, Inc. model UHP-76) with a capacity of 450 mm. The effective membrane area in these cells was 38.5 cm². Scanning electron microscope imaging of the coated PSf films was performed at the University of Colorado Nanomaterials Characterization Facility using a JSM-6480LV instrument.

### Synthesis and Characterization of Functional Monomers

### 1-{4-[2-(2-Hydroxy-ethoxy)-ethyl]piperazin-1-yl}-propenone (2)

To a flask containing 1-[2-(2-hydroxyethoxy)-ethyl]piperazine (5.00 g, 28.7 mmol, 100 mol %) was added CH₂Cl₂ (200 mL) and K₂CO₃ (39.67 g, 287.0 mmol, 1000 mol %). The flask was cooled to 0° C. using an ice-H₂O bath, and acryloyl chloride (2.47 g, 2.22 mL, 27.3 mmol, 95 mol %) was added drop-wise. The solution was then warmed to room temperature and stirred for 12 h. The solution was filtered, and the filtrate was transferred to a separatory funnel, washed with H₂O (100 mL) and dried (anhydrous MgSO₄). The solvent was then removed under reduced pressure (30 mm Hg) to give a crude white solid. Purification by flash chromatography (SiO₂) with 20:1 CH₂Cl₂/MeOH (v/v) afforded 2 (5.52 g, 84% yield) as a light yellow oil. ¹H NMR (400 MHz, CDCl₃): δ 2.58 m, 4H), 3.07 (t, 4H), 3.47 (t, 2H), 3.57 (t, 2H), 3.73 (t, 2H), 6.11 (dd, 1H), 6.25 (dd, 1H), 6.62 (dd, 1H). ¹³C NMR (100 MHz, CDCl₃); δ 45.4, 52.3, 55.2, 60.9, 63.6, 68.7, 72.3, 129.7, 131.5. IR (neat): 2804, 1628, 2953, 1705, 1450, 1342, 1211, 1100 cm⁻¹ HRMS (ES) calcd. for C₁₁H₂₀N₂O₂Na⁺: 251.1372; observed: 251.1375.

### 1-(1,4,7,10,13-Pentaoxa-16-aza-cyclooctadec-16-yl)-propenone (3)

To a flask containing 1-aza-18-crown-6 (1.00 g, 3.80 mmol, 100 mol %) was added CH₂Cl₂ (200 mL) and K₂CO₃ (1.05 g, 7.60 mmol, 200 mol %). The flask was cooled to 0° C. using an ice-H₂O bath and acryloyl chloride (0.688 g, 0.617 mL, 7.60 mmol, 200 mol %) was added drop-wise. The solution was warmed to room temperature and stirred for 12 h. The solution was filtered, and the filtrate was transferred to a separatory funnel, washed with H₂O (100 mL), and dried (anhydrous MgSO₄). The solvent was removed under reduced pressure (30 mm Hg) to afford the product 3 as a clear yellow oil (1.18 g, 98% yield). ¹H NMR (500 MHz, CDCl₃): δ 3.61-3.73 (m, 24H), 6.09 (dd, 1H), 6.20 (dd, 1H), 6.58 (dd, 1H). ¹³C NMR (125 MHz, CDCl₃); δ 46.4, 49.9, 69.4-71.5, 127.5, 131.4, 165.4 IR (neat): 3428, 2910, 1959, 1725, 1643, 1612, 1444, 1353, 1292, 1133, 987 cm⁻¹. HRMS (ES) calcd. for C₁₅H₂₇NO₆Na⁺: 340.1736; observed: 340.1729.

### N-Methyl-N-(2-methylamino-ethyl)-acrylamide (4)

To a flask containing N,N′-dimethylethylene diamine (0.827 g, 9.38 mmol, 100 mol %) was added CH₂Cl₂ (20 mL) and K₂CO₃ (1.29 g, 7.60 mmol, 100 mol %). The flask was cooled to 0° C. using an ice-H₂O bath, and acryloyl chloride (0.849 g, 0.762 mL, 9.38 mmol, 100 mol %) was added drop-wise. The solution was warmed to room temperature and stirred for 1 h. The solution was then filtered, and the filtrate was transferred to a separatory funnel, washed with H₂O (100 mL), and dried (anhydrous MgSO₄). The solvent was then removed under reduced pressure (30 mm Hg) to give a crude orange oil. Purification by flash chromatography (SiO₂) with 5:1 CH₂Cl₂/MeOH (v/v) afforded the product 4 as a clear yellow oil (0.87 g, 62% yield). ¹H NMR (400 MHz, CDCl₃) δ 2.00 (s, 3H), 2.05 (s, 3H), 2.93 (t, 2H), 3.00 (t, 2H), 6.11 (dd, 1H), 6.24 (dd, 1H), 6.67 (dd, 1H) ¹³C NMR (100 MHz, CDCl₃): δ 33.3, 34.3, 48.3, 49.8, 127.6, 130.5, 162.7. IR (neat): 3092, 3037, 2953, 1749, 1609, 1534, 1468, 1419, 1350, 1306 cm⁻¹. HRMS (ES) calcd. for C₇H₁₄N₂ONa⁺: 165.1004; observed: 165.1006.

### Trimethyl-(4-vinyl-benzyl)-phosphonium bromide (5a)

To a 50-mL pressure tube equipped with a stir bar and a PTFE cap was added 4-vinylbenzyl bromide (2.74 g, 13.9 mmol, 100 mol %) and CH₃CN (30 mL). Trimethylphosphine (1.16 g, 1.58 mL, 15.3 mmol, 110 mol %) was added. The reaction mixture was heated to 40° C. for 2 h, and a white solid formed. The flask was then cooled to room temperature and filtered to afford the product 5a as a white solid (3.72 g, 98% yield). ¹H NMR (400 MHz, DMSO-d₆): δ 1.78 (s, 9H), 3.75 (s, 2H), 5.30 (d, 1H), 5.87 (d, 1H), 6.74 (dd, 1H), 7.28 (dd, 2H), 7.53 (d, 2H). ¹³C NMR (100 MHz, DMSO-d₆) δ 18.7, 42.3, 114.3, 127.2, 126.9, 128.1, 132.6, 135.2. IR (thin film, MeOH): 3399, 2967, 2933, 2877, 1630, 1512, 1464, 1410, 1087, 863 cm⁻¹. HRMS (ES) calcd. for C₂₄H₃₆BrP₂ (M⁺M⁺Br⁻): 465.1476; observed: 465.1493.

### Trimethyl-(4-vinyl-benzyl)-phosphonium chloride (5b)

To a 50-mL pressure tube equipped with a stir bar and a PTFE cap was added 4-vinylbenzyl chloride (3.11 g, 20.4 mmol, 100 mol %) and CH₃CN (40 mL). Trimethylphosphine (2.33 g, 3.17 mL, 30.6 mmol, 150 mol %) was added. The reaction mixture was heated to 40° C. for 2 h, during which time a white solid formed. The flask was then cooled to room temperature and filtered to afford the product 5b as a white solid (4.52 g, 97% yield). ¹H NMR (400 MHz, DMSO-d₆): δ 1.81 (s, 9H), 3.86 (s, 2H), 5.28 (d, 1H), 5.86 (d, 1H), 6.74 (dd, 1H), 7.30 (dd, 2H), 7.51 (d, 2H). ¹³C NMR (100 MHz, DMSO-d₆): δ 18.5, 42.2, 115.1, 127.6, 127.0, 128.1, 132.8, 135.4. IR (thin film, MeOH): 3456, 2977, 2943, 2841, 1625, 1515, 1469, 1415, 1097, 856 cm⁻¹. HRMS (ES) calcd. for C₂₄H₃₆CIP₂ (M⁺M⁺Cl⁻): 421.1981; observed: 421.1994.

### Tripropyl-(4-vinyl-benzyl)-phosphonium chloride (5c)

To a 50-mL pressure tube equipped with a stir bar and a PTFE cap was added 4-vinylbenzyl chloride (3.25 g, 21.3 mmol, 100 mol %) and CH₃CN (30 mL). Tri(n-propyl)phosphine (3.75 g, 4.68 mL, 23.4 mmol, 110 mol %) was added, and the reaction mixture was heated to 40° C. for 2 h during which time a white solid formed. The flask was then cooled to room temperature, and the solids were filtered off and washed with hexanes to afford the product 5c as a white solid (7.50 g, 99% yield). ¹H NMR (500 MHz, DMSO-d₆): δ 0.97 (t, 9H), 1.50 (m, 6H), 2.12 (m, 6H), 3.82 (s, 2H), 5.30 (d, 1H), 5.88 (d, 1H), 6.74 (dd, 1H), 7.32 (dd, 2H), 7.53 (d, 2H). ¹³C NMR (125 MHz, DMSO-d₆): δ 15.8, 17.2, 31.4, 35.2, 114.3, 126.3, 127.2, 128.3, 133.2, 134.5. IR (thin film, MeOH): 3452, 2963, 2913, 2877, 1643, 1522, 1457, 1413, 1088, 866 cm⁻¹. HRMS (ES) calcd. for C₃₆H₆₀CIP₂ (M⁺M⁺Cl⁻): 589.3859; observed: 589.3835.

### Tributyl-(4-vinyl-benzyl)-phosphonium chloride (5d)

(Akelah, 2007). To a 50-mL pressure tube equipped with a stir bar and a PTFE cap was added 4-vinylbenzyl chloride (3.25 g, 21.3 mmol, 100 mol %) and CH₃CN (30 mL). Tri(n-butyl)phosphine (4.09 g, 5.05 mL, 20.2 mmol, 110 mol %) was added, and the reaction mixture was heated to 40° C. for 2 h during which time a white solid formed. The flask was cooled to room temperature, and the solids were filtered off and washed with hexanes to afford the product 5d as a white solid (7.40 g, 98% yield). The characterization data for this compound matched literature values (Akela, 2007).

### Triphenyl-(4-vinyl-benzyl)-phosphonium chloride (5e)

(Akela, 2007). To a 100-mL round-bottom flask equipped with a stir bar was added triphenylphosphine (10.00 g, 38.13 mmol, 100 mol %) and CH₃CN (40 mL). 4-vinylbenzyl chloride (11.60 g, 10.71 mL, 76.01 mmol, 200 mol %) was added, and the reaction mixture was heated to 85° C. for 16 h during which time a white solid formed. The flask was then cooled to room temperature, and the solids were filtered and washed with Et₂O to afford the product as a white solid (15.50 g, 98% yield). The characterization data for this compound matched literature values (Akela, 2007).

### Triphenyl-(4-vinyl-benzyl)-phosphonium bis(trifluoromethylsulfonyl)amide (5f)

To a 100-mL round-bottom flask equipped with a stir bar was added deionized H₂O (50 mL) and 5e (5.00 g, 12.1 mmol, 100 mol %). The flask was heated to 60° C. to dissolve 5e, followed by addition of lithium bis(trifluoromethane)sulfonimide (3.47 g, 12.1 mmol, 100 mol %). A solid precipitate immediately formed, which was then filtered and washed with deionized H₂O. After drying in vacuo, the product obtained was a white solid (6.77 g, 85% yield). ¹H NMR (500 MHz, DMSO-d₆): δ 5.24 (s, 2H), 5.28 (d, 1H), 5.82 (d, 1H), 6.65 (dd, 1H), 6.96 (dd, 2H), 7.68 (d, 2H), 7.69-7.77 (m, 12H) 7.91 (m, 3H). ¹³C NMR (125 MHz, DMSO-d₆): δ 30.74, 114.5, 126.2, 127.1, 128.3, 128.4, 128.9, 133.1, 134.8 136.7, 137.3. IR (thin film, MeOH): 3387, 2961, 2912, 2901, 1662, 1534, 1463, 1399, 1087, 889 cm⁻¹. HRMS (ES) calcd. for C₅₆H₄₈F₆NO₄P₂S₂ (M⁺M⁺Tf₂N⁻): 1038.2404; observed: 1038.2412.

### Triethyl-(4-vinyl-benzyl)-ammonium chloride (6a)

(Zarras, 2000)

To a 50-mL pressure tube equipped with a stir bar and a PTFE cap was added 4-vinylbenzyl chloride (3.12 g, 19.7 mmol, 100 mol %) and CH₃CN (30 mL). Triethylamine (2.98 g, 4.11 mL, 29.5 mmol, 150 mol %) was added, and the reaction mixture was heated to 40° C. for 2 h during which time a white solid formed. The flask was then cooled to room temperature, and the solids were filtered and washed with hexanes to afford the product 6a as a white solid (4.97 g, 99% yield). The characterization data for this compound matched reported literature values (Zarras, 2000).

### Tripropyl-(4-vinyl-benzyl)-ammonium chloride (6b) (Zarras, 2000)

To a 50-mL pressure tube equipped with a stir bar and a PTFE cap was added 4-vinylbenzyl chloride (3.25 g, 21.3 mmol, 100 mol %) and CH₃CN (30 mL). Tripropylamine (3.20 g, 4.25 mL, 22.4 mmol, 110 mol %) was added, and the reaction mixture was heated to 40° C. for 2 h during which time a white solid formed. The flask was then cooled to room temperature, and the solids were filtered and washed with hexanes to afford the product 6b as a white solid (6.59 g, 99% yield). The characterization data for this compound matched reported literature values (Zarras, 2000).

### Tributyl-(4-vinyl-benzyl)-ammonium chloride (6c)

(Zarras, 2000). To a 50-mL pressure tube equipped with a stir bar and a PTFE cap was added 4-vinylbenzyl chloride (5.42 g, 35.5 mmol, 100 mol %) and CH₃CN (30 mL). Tri(n-butyl)amine (6.57 g, 8.45 mL, 35.5 mmol, 100 mol %) was added, and the reaction was heated to 40° C. for 2 h during which time a white solid formed. The flask was cooled to room temperature, and the solids were filtered off and washed with hexanes to afford the product 6c as a white solid (11.39 g, 95% yield). The characterization data for this compound matched reported literature values (Zarras, 2000).

### Tris-(2-hydroxy-ethyl)-(4-vinyl-benzyl)-ammonium chloride (6d)

To a 50-mL pressure tube equipped with a stir bar and a PTFE cap was added 4-vinylbenzyl chloride (1.26 g, 7.53 mmol, 100 mol %) and CH₃CN (30 mL). Triethanolamine (1.12 g, 1.0 mL, 8.28 mmol, 110 mol %) was added, and the reaction mixture was heated to 40° C. for 2 h during which time a white solid formed. The flask was then cooled to room temperature, and the solvent was removed under reduced pressure (30 mm Hg) to give a crude yellow oil. The oil was washed with hexanes (3×10 mL), and the hexanes was decanted off to afford the product 6d as a light yellow oil (2.09 g, 92%). ¹H NMR (400 MHz, DMSO-d₆): δ 3.80 (t, 6H), 4.32 (t, 6H), 4.76 (s, 2H), 5.28 (dd, 1H), 5.86 (dd, 1H), 6.74 (dd, 1H), 7.42 (dd, 2H), 7.48 (d, 2H). ¹³C NMR (100 MHz, DMSO-d₆): δ 57.1, 61.8, 63.4, 115.1, 126.3, 128.8, 133.5, 134.5, 134.7; IR (thin film, MeOH): 3377, 2955, 2945, 2899, 1623, 1555, 1476, 1401, 1098, 843 cm⁻¹. HRMS (ES) calcd. for C₃₆H₄₈ClN₂O₆ (M⁺M⁺Cl⁻¹): 567.3201; observed: 567.3222

### Tris-[2-(2-methoxy-ethoxy)-ethyl]-(4-vinyl-benzyl)-ammonium chloride (6e)

To a 50-mL pressure tube equipped with a stir bar and a PTFE cap was added 4-vinylbenzyl chloride (5.42 g, 35.5 mmol, 100 mol %) and CH₃CN (30 mL). Tris(2-(2-methoxyethoxy)ethyl)amine (11.48 g, 11.35 mL, 35.48 mmol, 100 mol %) was added, and the reaction mixture was heated to 40° C. for 2 h during which time a white solid formed. The flask was then cooled to room temperature, and the solids were filtered off and washed with hexanes to afford the product 6e as a white solid (7.40 g, 98% yield). ¹H NMR (400 MHz, DMSO-d₆): δ 3.80 (t, 6H), 4.32 (t, 6H), 4.76 (s, 2H), 5.28 (dd, 1H), 5.86 (dd, 1H), 6.74 (dd, 1H), 7.42 (dd, 2H), 7.48 (d, 2H). ¹³C NMR (100 MHz, DMSO-d₆): δ 57.1, 61.8, 63.4, 115.1, 126.3, 128.8, 133.5, 134.5, 134.7; IR (thin film, MeOH): 3345, 2978, 2931, 2891, 1632, 1551, 1473, 1432, 1056, 856 cm⁻¹. HRMS (ES) calcd. for C₄₈H₈₄ClN₂O₁₂ (M⁺M⁺Cl⁻): 915.5713; observed: 915.5731.

Monomer 7

(Zhou, 2007). This compound was synthesized as previously described in the literature. Spectroscopic characterization and purity data were consistent with reported values (Zhou, 2007).

FIG. 5b illustrates a synthesis scheme and lists several of the monomers used in the present experiments.

### Polymerization of Free-Standing Films of Functional Monomers for Polymer Characterization.

Cross-linked free-standing films of each class of monomer (poly(ethylene glycol) acrylate and PEGDA: 1; acrylamide based: 2-4; styrene-based phosphonium: 5; and styrene-based ammonium: 6 were prepared to ensure that they were polymerizing under our conditions. Solutions containing 10 wt % monomer in methanol were initially made, and then 5 mol % cross-linker (1,6-hexanediol diacrylate for the acrylamide- and acrylate based monomers 1a and 2-4, or 1,4-divinylbenzene for the styrene-based monomers 5a-f and 6a-e) and 1 wt % HMP photoinitiator with respect to monomer were added to the solution. No additional cross-linker was added to monomer 1b because 1b is a diacrylate and thus inherently cross-linkable upon chain-addition polymerization. An appropriate amount of monomer solution was pipetted onto a Ge crystal. The solvent was allowed to evaporate at room temperature and atmospheric pressure leaving a thin film of monomer, cross-linker agent, and photoinitiator. An FT-IR spectrum of the pre-polymerized film was then obtained. The coated Ge crystal was then sealed in the polymerization chamber, purged with argon three times and photopolymerized for 30 min. An IR spectrum of the polymerized film was then taken and compared to the pre-polymerized film to determine degree of polymerization.

### Representative Characterization Data.

IR spectra of the films were taken both before and after photo-initiated radical cross-linking. All cross-linked films were flexible, clear, colorless, and insoluble in organic solvents. The degree of polymerization was calculated to be ≧95% from the loss in absorbance intensity of the characteristic olefinic FT-IR bands in the 700-1100 cm⁻¹ range for the acrylate (810 cm⁻¹), acrylamide (795 cm⁻¹), and styrene (989 or 1032 cm⁻¹) groups (Gordon, 1973); and at 1650 cm⁻¹ for the 1,3-diene group (Zhou, 2007). Poly(1b): 3534, 2878, 1723, 1458, 1447, 1353, 1257, 1115, 864 cm⁻¹; poly(3): 3471, 2915, 1972, 1727, 1448, 1355, 1295, 1126, 944 cm⁻¹; poly(5a): 3401, 2965, 2930, 2873, 1629, 1511, 1461, 1085, 859 cm⁻¹; poly(6b): 3395, 2961, 2940, 2874, 1635, 1557, 1473, 1382, 1036, 870 cm⁻¹; poly(7): FT-IR and powder XRD data were consistent with those reported in the literature (Zhou, 2007). The insolubility and nearly complete polymerization verify that the samples are cross-linked polymer films.

### General Procedure for Preparation of Functional Polymer Coatings on PSf Membrane Supports for Static Protein Adsorption Studies.

Solutions containing 10 wt % monomer in methanol were initially made, and then 5 mol % cross-linker (1,6-hexanediol diacrylate for the acrylamide and acrylate-based monomers (1a, 2-4) or 1,4-divinylbenzene for the styrene-based monomers (5a-f and 6a-e)) and 1 wt % HMP photoinitiator with respect to monomer were added to the solution. No addition cross-linker was added to monomer 1b. A custom-made roll-casting apparatus was used to evenly spread the monomer solution onto a clean PSf membrane. The solvent was allowed to evaporate at ambient temperature (21±1° C.) in the air, and the resulting monomer coating was photopolymerized by 365 nm light (8.5 mW/cm²) for 30 min under an argon atmosphere. A 25-mm diameter metal die was used to cut samples for subsequent static protein exposure experiments.

All coated membranes for the static protein exposure experiments were made in this fashion except for monomer 7, which was prepared by hot-pressing and photo-cross-linking into a Solupor E075-9H01A polyethylene fiber matte support as described in the literature (Zhou, 2007). For the static protein adsorption comparison studies with membranes coated with nanostructured poly(7), poly(1b) and cross-linked poly(5a) were hot-pressed through Solupor E075-9H01A support and then photo-cross-linked. This was done in order to have the same membrane support and coating configuration for the most accurate performance comparison, because the processing limitations of the lyotropic LC gel of 7 has not allowed it to be solution-cast to form the desired LLC phase on membrane supports other than Solupor E075-9H01A (Zhou, 2007).

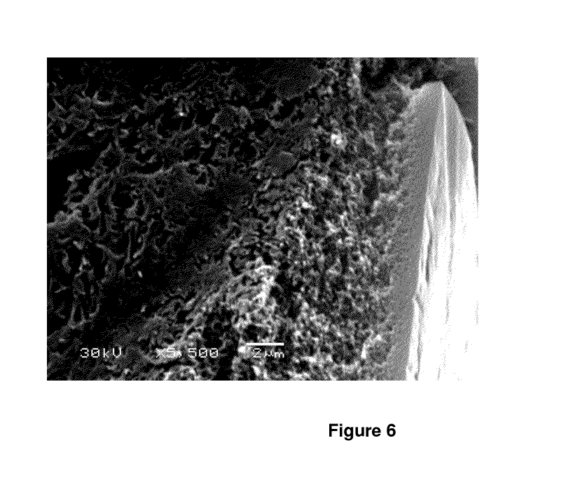

The insolubility of the thin polymer coatings and the presence of the thick underlying support made useful spectroscopic characterization of the composite membranes untenable. However, SEM imaging of the composite membranes showed good dense top films that are ca. 0.5-1.5 μm in thickness (see representative SEM cross-sectional photo in FIG. 6). Samples were fractured in liquid nitrogen to ensure a clean edge for imaging. The membranes were sputtered in gold to prevent charging. The insolubility of the polymerized coatings and the initial pure water flux stability of the resulting composite membranes are good indicators of the quality of the cross-linked coatings.

### Static Protein Exposure Experiments.

The coated side of the resulting coated composite membranes described above was exposed to 1.0 mL of 1.0 g/L BSA or 1.0 g/L Fg protein solutions that were buffered at pH 7.4 (using 0.010 M PBS) in separate experiments. After 1 h of static exposure at ambient temperature, the solution was decanted and the membrane was washed 10 times with PBS buffer solution and then 5 times with deionized water to remove any leftover protein solution or loosely adsorbed protein. Control experiments examining the use of different adsorption times (1, 2 and 4 h) were conducted. While not necessarily long enough to reach complete equilibrium, a time of 1 h was chosen after these experiments showed that relatively little extra protein was adsorbed after a 1-h exposure time. The membrane samples were then left to air-dry for 1 h at ambient temperature. The protein-exposed side of the test membrane was then exposed to 500 μL of a solution of 0.010 M PBS buffer containing 2.5 wt % sodium dodecylsulfate. The protein-exposed membrane was sonicated in this solution for 5 min to completely desorb all protein off the membrane surface. The complete (i.e., 100%) desorption of surface protein using this technique was confirmed by control experiments on test membranes containing set amounts of protein on the surface that were delivered using known amounts of stock BSA and Fg solutions.

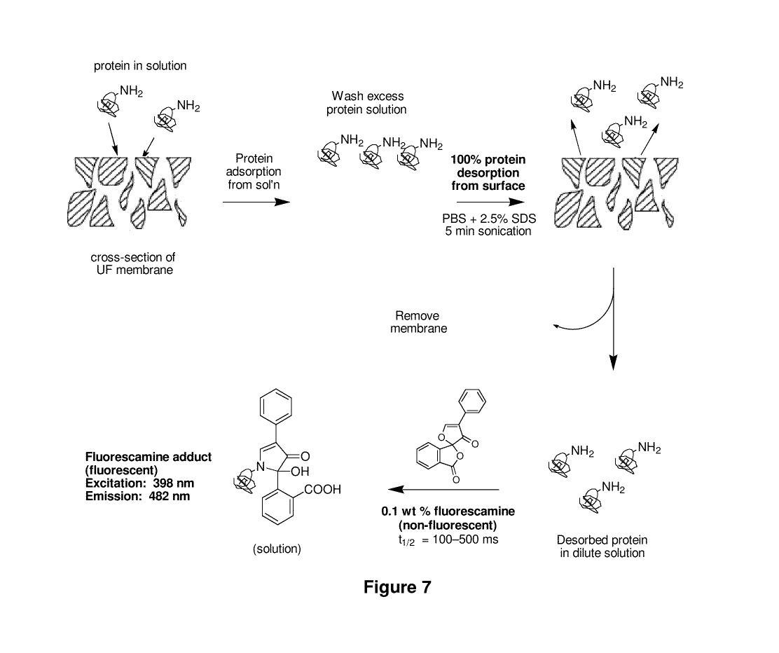

The protein concentration of the solution was then determined using a fluorimetric assay similar to other procedures for protein detection in dilute solutions (Sogawa, 1978; Chen, 2006; Udenfriend, 1972). Specifically, 300 μL of the desorption solution, 600 μL of borate buffer (0.1 M, pH 8.5), and 300 μL of 0.1 wt % fluorescamine in acetonitrile was mixed and allowed to react for 5 min. Under basic conditions, fluorescamine selectively reacts with the primary amines found on proteins to form a fluorescent adduct with an excitation and emission peak at 398 and 482 nm, respectively. The intensity of the emission peak is directly proportional to the protein concentration. Absolute protein concentrations were determined by calibrating the assay with standard protein solutions. From these experiments the amount of protein adsorption on the membrane (mg/m²) was calculated. The experimental error of these measurements was determined by calculating the standard deviation of at least 4 independent sample runs. FIG. 7 presents a schematic of the procedure.

Standard solutions of BSA and Fg were used to calibrate the fluorimetry for every experiment. A linear regression was performed to get a calibration curve. The concentrations of interest for these experiments all lied within the linear range of this assay. To ensure complete adsorption off of the protein adsorbed membrane surface control experiments were conducted. A known amount of protein solution in PBS, similar to the amount of protein normally adsorbed by PSf membranes, was deposited on the membrane and allowed to dry. Then, the protein desorption method used in this experiment, sonication in a known amount of 2.5 wt % SDS in PBS solution for 5 min. This solution was then assayed as normal to give a concentration corresponding to complete desorption.

### General Procedure for Preparation of Functional Polymer Coatings on PSf Membrane Supports for Protein Absorption Studies Under Dynamic Flow.

The preparation for composite membranes coated with cross-linked poly(1b) was performed as follows (Ju, 2008): An initial monomer coating solution was prepared by mixing 1b, PEO, water, and 1-hydroxycyclohexyl phenyl ketone (HCPK) photoinitiator (water: 80 wt %; HCPK: 1 wt % based on PEGDA (i.e., 10⁻² g HCPK/(g PEGDA+HCPK)); PEO: 2 wt % based on water (i.e., 0.02 g PEO/(g PEO+water)). The PSf support membranes were soaked in methanol to remove any dust on the top surface and dried in air before coating. An automatic drawdown machine was used to spread the pre-polymerization mixture on the top surface of the dried support membrane with a coating rod size of 0 and a coating speed of 1 inch/s. After allowing the solvent to evaporate, the monomeric coating was polymerized by exposing the coated membrane to UV light (wavelength: 312 nm) for 90 s in an argon environment to inhibit the interference of O₂ with the polymerization.

Composite PSF membranes coated with films of 2, 3, 5a, 5b, 5c, 6b, and 6e were prepared as follows: PSf support membranes were cleaned and stored in pure water, and were dried under a heating lamp at 60° C. before coating. The coating mixtures, each containing 2 wt % monomer and 0.2 wt % HCPK in methanol (no photoinitiator), was then sprayed onto the heated PSf membrane surface by using a spray bottle. After the evaporation of the methanol solvent, the coated PSf membrane surface was exposed to UV light at a wavelength of 312 nm for 5 min under nitrogen to polymerize the monomers. The coating process and photopolymerization process was repeated one more time to ensure a full coverage of monomers on the PSf surface.

Again, the insolubility of the thin polymer coatings and the presence of the thick underlaying PSf support made useful spectroscopic characterization of the composite membranes untenable. However, SEM imaging of the composite membranes showed good dense top films ca. 0.5-1.5 μm in thickness (see representative FIG. 6.) The insolubility of the polymerized coatings and the initial pure water flux stability of the resulting composite membranes are good indicators of the quality of the coatings.

### Protein Adsorption and Membrane Fouling Studies Under Dynamic Flow Conditions.

The separation performance of uncoated PSf and the coated PSf membranes described above was studied using BSA dead-end filtration conducted at ambient temperature. The BSA protein used throughout this study was dissolved in PBS aqueous solution (pH=7.4, PBS) at a concentration of 1 g/L., and a 76-mm I.D. dead-end cell was used for the filtration studies. In these dynamic flow studies, pure water was filtered initially through the membrane samples at a transmembrane pressure difference of 3.4 bar for 0.5 h to compact the test membranes and achieve a stable water flux. The amount of permeate was recorded by a digital balance connected to a computer as a function of time, and the pure water permeance (Pₒ) was calculated as follows:

$${P}_{O} = \frac{Δ V}{A \cdot Δ t \cdot Δ p} \qquad ( 3 )$$

where Δp is the transmembrane pressure difference, ΔV is the effluent volume at time interval Δt, and A is the membrane surface area. BSA filtration was then conducted for 2 h after switching the feed solution to 1 g/L BSA PBS solution and re-pressurizing the cell to 2.1 bar. The steady state permeance during BSA filtration water (P₂) was then calculated. The water permeance relative to Pₒ was reported as a function of filtration time for measured membranes. The permeate sample was analyzed by a UV-visible spectrophotometer, and the BSA concentration was obtained using Beer's Law and calibration with standard BSA solutions. The % rejection (R) of BSA was calculated as follows:

$$R = ( 1 - \frac{{C}_{P}}{{C}_{F}} ) \cdot 100 \% \qquad ( 4 )$$

where C_{P} is the permeate BSA concentration and C_{F} is the feed BSA concentration, which is 1 g/L. After BSA filtration, the membrane surface was rinsed 3 times with pure water, and the pure water permeance (P_{f}) was measured again at a transmembrane pressure difference of 3.4 bar. The value (P₂/P₀) represents the relative pure water permeance after protein fouling and is also used as a measurement of protein fouling.

### Results and Discussion

### Aqueous Protein Adsorption Studies Under Static Exposure Conditions

The static protein exposure experiments were conducted on commercially available ultraporous composite PSf membranes (General Electric, type A-1) coated with lightly radically photo-cross-linked versions of each of the functionalized monomers shown in FIG. 5a, (i.e., with cross-linked 5 mol % added cross-linker), with the exception of poly(ethylene glycol)-diacrylate (PEGDA: M.W.=743 g/mol, n=13) (1b), which was heavily cross-linked in its pristine state. The membranes in these static protein adsorption studies were prepared by roll-casting a 10 wt % solution of the monomer in methanol with a given amount of cross-linking agent and photo-initiator (2-hydroxyl-2-methylpropiophenone). The solvent was allowed to evaporate, and the thin pre-polymer coating was then photopolymerized using a 365 nm UV lamp for 30 min at ambient temperature under an argon atmosphere. Complete conversion of the monomer to a polymer was verified by IR analysis. Polymer coatings on PSf membranes were confirmed by SEM. Dense, thin films of the functional coating (in this case, poly (6b) are visible in FIG. 6 (right side of the figure)). The visible polymer coatings on the PSf membranes are approximately 0.2-1.0 micrometers thick. Attempts were also made to measure the water contact angles of each membrane sample. However, some swelling and wetting of the membrane surface b the added water occurred for the more hydrophilic coatings, and accurate static contact angles could not be determined for these sample. In almost all cases, the polymer coatings increased the hydrophilicity of the PSf membranes.

In order to ascertain the relative ability of the various functional polymer coatings to resist protein adsorption under static exposure conditions, the top coated side of each test film was exposed to 1 g/L solutions of bovine serum albumin (BSA) and fibrinogen (Fg) buffered with a phosphate buffer saline solution (PBS, pH=7.4) using the feed reservoir in a 25-mm I.D. dead-end filtration cell in non-flowing mode for 1 h at ambient temperature. BSA (M.W.=66 kDa, isoelectric point (iP)=4.7), and Fg (M.W.=340 kDa, iP=5.5) are proteins that have been used extensively as model substrates for protein-fouling studies (Nakanishi, 2001). After washing off the excess protein solution, the amount of BSA or Fg adsorbed on the top surface of the coated membranes was then determined by quantitatively desorbing the protein from the membrane into solution and interpolating the amount of protein by fluorescence analysis. This was done by sonicating the membranes in a given amount of 2.5 wt % sodium dodecylsulfate in PBS solution and assaying the amount of protein released back into solution by a fluorescence assay using a fluorescamine. Fluorescamine, which reacts quantitatively and quickly with the primary amines found on proteins to form a fluorescent tag, has been widely used to determine protein concentrations in dilute solutions (Sogawa, 1978; Chen, 2006; Udenfriend, 1972). Control experiments utilizing protein solutions of known concentration, standard amounts of protein placed on membrane surfaces, and fluorescence calibration plots, all confirmed the accuracy and precision of this method. Using these procedures, the amount of protein absorbed per unit area for each type of polymeric coating was determined and then compared to ascertain quantitatively their protein-resistance properties in this test configuration. Blank, uncoated PSf membrane was used as a control for high protein adsorption, and poly(1a) and poly(1b) (i.e., cross-linked hydroxyl-capped PEG acrylate and PEG diacrylate, respectively) were used as benchmark references for a relatively well-known, low protein absorbing material (i.e. PEG) (Kang, 2008).

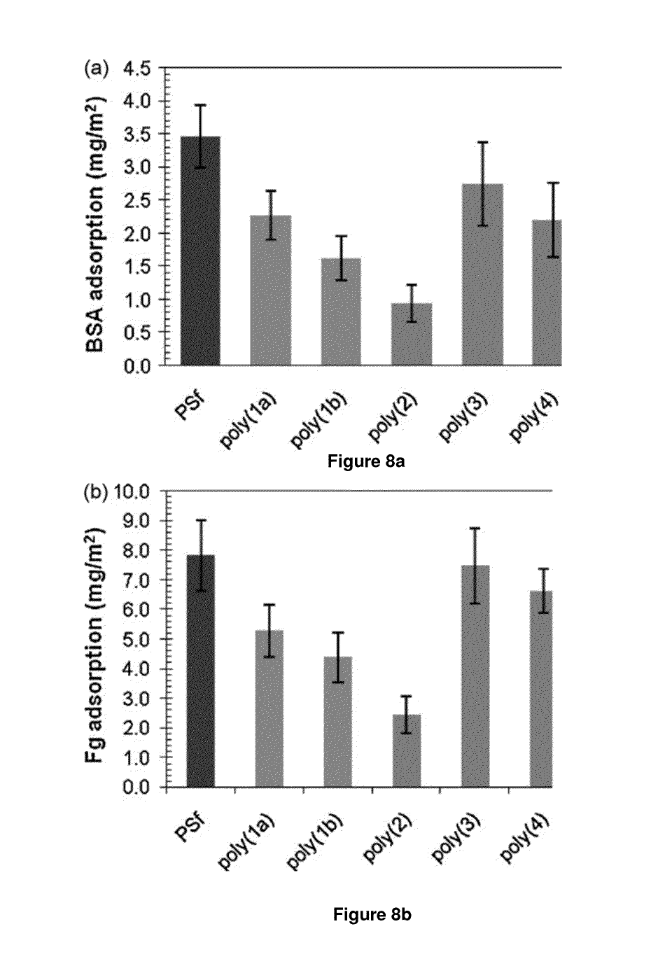

FIGS. 8a and 8b show the amounts of BSA and Fg absorbed under static exposure conditions for uncoated PSf; and PSf coated with PEG-based poly(1a) and poly(1b) and polymeric analogs (i.e., poly(2), poly(3), and poly(4)) of three of the best protein-resistant functional groups reported in prior SAM studies (i.e., the piperazine, azo-crown-ether, and ethylene diamine groups, respectively (Ostuni, 2001)). As can be seen in FIGS. 8a and 8b, Fg adsorption was much higher than BSA in all cases, indicating that Fg is a “stickier” protein under these exposure conditions. As expected, the cross-linked PEG-coated membranes adsorbs significantly less protein than the uncoated PSf control sample, indicating that oligo(ethylene oxide) groups are good-protein-resistant groups.

It should be noted that the lightly cross-linked, hydroxyl capped PEG acrylate coating (poly(1a)) and the fully cross-linked PEG diacrylate coating (poly(1b)) were both experimentally found to adsorb a similar amount of protein within experimental error over multiple experiments (e.g. see FIGS. 8a and 8b). For simplicity, in the figures following FIGS. 8a and 8b only the data for the slightly more resistance protein-resistant PEG diacrylate coating poly (1b) will be shown to illustrate the performance of a benchmark, low-protein-adsorption PEG reference coating.

While piperazine-based poly(2) adsorbed less protein than PEG-based poly(1b), the other functionalized polymers, poly(3) and poly(4), adsorbed almost as much protein as uncoated PSf membrane. In contrast, in prior SAM studies, the functional groups in the four polymers mentioned above all showed similar protein-resistance and adsorbed less than a 10% monolayer of Fg when presented as SAM coatings (Ostuni, 2001). Also, the PEG-based SAMs adsorbed <1% of a monolayer of protein. While poly(2) exhibits very low protein adsorption and gives a promising result, all the polymer analogues of the SAMs (including PEG) do not appear to be as protein-resistant when presented as amorphous polymer coatings on water filtration membranes. The functional groups in the polymers of the SAM-based compounds (2, 3, and 4) are protein-resistant in some cases, but not as protein-resistant as one would expect from the prior SAM functional group study (Ostuni, 2001). One interesting and self-consistent observation between the static BSA and Fg exposure tests is that poly(2) is more protein-resistant than poly(1b), suggesting that the piperazine functional group is superior to oligo(ethylene glycol)s in this coating/substrate configuration, and under these specific test conditions.

There are several differences between the SAM and polymer systems that could explain the observed trend in protein adsorption resistance of the four functionalized polymer coatings, compared to that expected from prior SAM studies with the same functional groups. First, SAM surfaces are highly ordered systems with a very dense concentration of functional groups and have nanoscale smoothness (Mrksich, 1995). SAMS are ideal platforms for understanding the fundamentals of protein-surface interactions due to their surface uniformity, highly controlled environment, and compatibility to a variety of analytical techniques (Mrksich, 1995). However, when identifying new functional groups that resist the adsorption of proteins, there are several other factors that may influence protein adsorption aside from the specific chemical functional groups under examination. It has been shown in the literature that PEG-functionalized SAMs that form an all-trans alkyl chain conformation are not protein-resistant, whereas the same PEG-based SAM with a helical alkyl chain conformation adsorbs almost no protein (Feldman, 1999; Harder, 1998) In another study, very low protein adsorption was observed when a sample with 60% coverage by a PEG-based SAM was exposed to protein; however, a sample with 100% coverage of the same SAM showed high protein adsorption (Vanderah, 2004). In these cases, the effects of functional group density and conformation play an important, if not a more important, role than the type of chemical functionality presented at the surface. Unlike SAM model systems, composite membrane surfaces are usually rough, porous, and based on organic polymer substrates. Possibly more importantly, filtration membranes also lack the surface chemical uniformity that plays an important role in a SAM's inertness to protein adsorption. These differences in surface environment may explain the observed differences in protein adsorption behavior between the same functional groups presented as a SAM on a smooth Au or Ag substrate and as a polymer coating on a porous membrane surface.

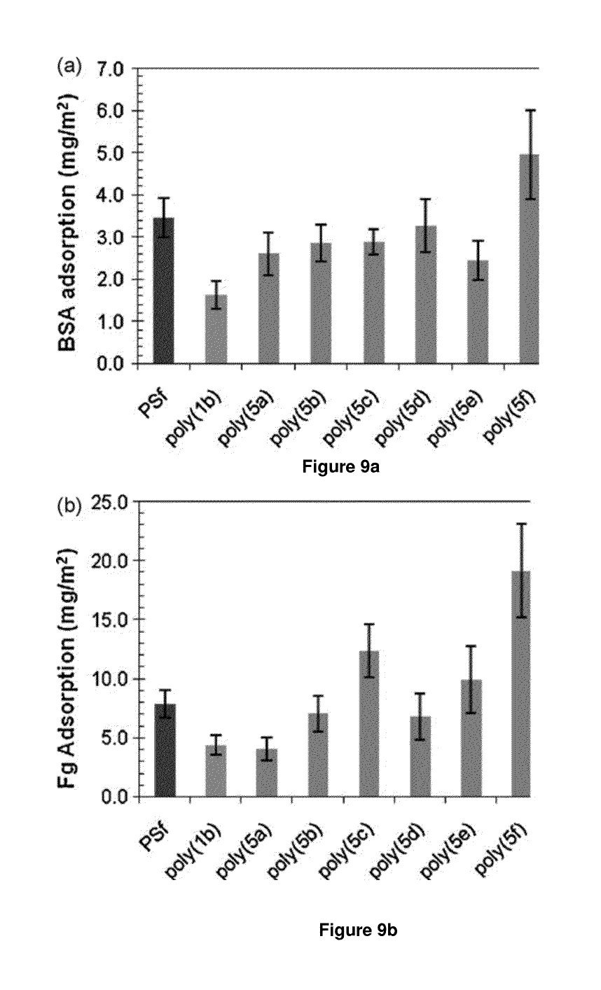

FIGS. 9a and 9b show the static BSA and Fg adsorption behavior of the new quaternary phosphonium functionalized polymer coatings vs. that of uncoated PSf and the PEG-based poly(1b) coating material. In general, quaternary phosphonium- and ammonium-functionalized polymers have not been previously examined for their resistance to non-specific protein adsorption. As can be seen in FIGS. 9a and 9b, the phosphonium-based polymers shown in the current study (poly(5a) to poly(5e)) are only mildly resistant to the adsorption of both test proteins at best. Only poly(5a) (R=—CH₃, X=Br⁻) exhibits good resistance to both static BSA and Fg adsorption at levels similar to that of the benchmark PEG-based poly(1b) coating. Increasing the length of the organic substituents on the phosphonium group has the effect of increasing the adsorption level of Fg, while this manipulation only has a minimal effect on BSA adsorption. Changing the anion from Br⁻ to a Cl⁻ (c.f., poly(5a) and poly(5b)), and from Cl⁻ to Tf₂N⁻ (c.f., poly(5e) and poly(5f)), appear to only increase the adsorption of both BSA and Fg.

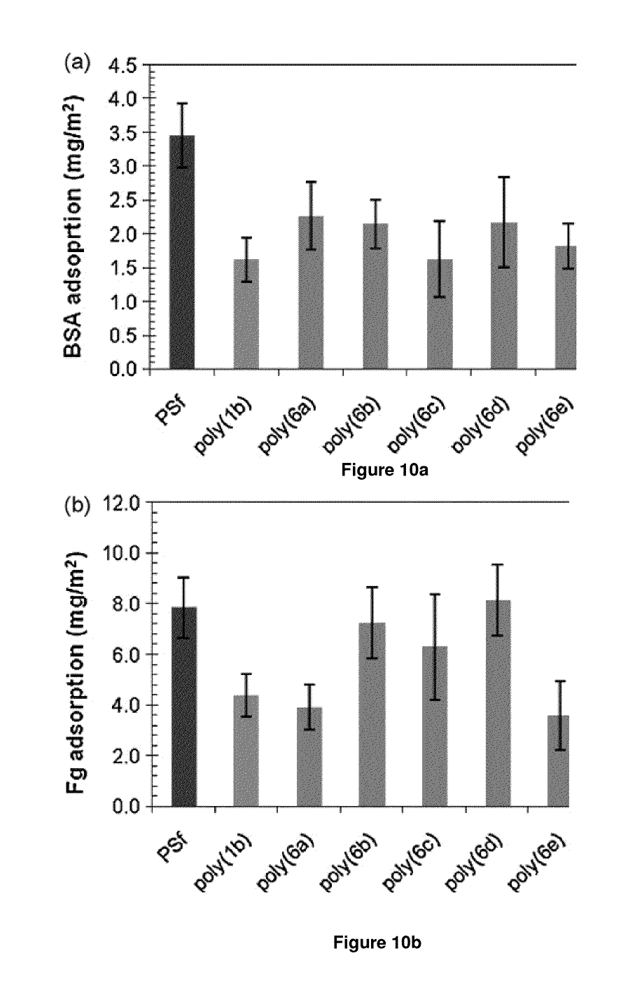

FIGS. 10a and 10b show that the static adsorption of BSA and Fg on ammonium-based polymers is, in general, less than the analogous phosphonium-based polymers under the same static exposure conditions (c.f., poly(5c) vs. poly(6b); and poly(5d) vs. poly(6c) for BSA only). As can be seen in FIGS. 10a and 10b, increasing the length of the alkyl substituents on the ammonium polymers (i.e., poly(6a) to poly(6c)) has little effect on BSA adsorption but increases Fg adsorption. The ammonium-functionalized polymer with a more hydrophilic 2-hydroxylethyl organic substituent (poly(6d)) shows higher protein adsorption, while the analogue with the longer 2-(methoxylethoxyl)ethyl substituent (poly(6e)) shows a significant decrease in protein adsorption when compared to the n-alkyl ammonium polymers.

The best quaternary “-onium”-based polymers are comparable to the PEG-based polymer coating poly(1b) with respect to overall static protein adsorption resistance. However, one major advantage that these phosphonium- and ammonium-functionalized polymers have over PEG-based polymers is their inherent chemical stability. Quaternary phosphonium and ammonium groups are much more resistant to reduction-oxidation and acid-base reactions than oligo(ethylene oxide) groups (Branch, 2001; Kawai, 2002). These properties potentially allow polymer coatings with quaternary phosphonium and ammonium groups to be used in medical devices that need to be protein-resistant over long periods of time, or in separation systems that operate in or require chemical cleaning under harsh conditions.

It should be noted that the observed low protein adsorption behavior of these ionic polymers is somewhat unusual and unexpected. In general, it has been empirically shown that protein-resistant organic functional groups are commonly non-ionic and hydrophilic (Nakanishi, 2001I Ostuni, 2001). Some researchers believe that these characteristics help these functional groups minimize the attractive charge-charge and hydrophobic interactions between the protein and surface, thereby causing lower adsorption (Kang, 2007; Nilsson, 1990). Another theory is that non-ionic, hydrophilic functional groups stabilize an interfacial water layer above the surface, making it more thermodynamically unfavorable for a protein to approach the surface and adsorb on to it (Ostuni, 2001; Harder, 1998). These theories do not account for the low protein adsorption seen in these ionic functionalities.

The kosmotrope theory best describes the low protein adsoprtion of these ionic functionalities (Kane, 2003). While we will not speculate on a mechanism for the resistance of these ionic phosphonium- and ammonium-functionalized polymer coatings, it is interesting that they lack the traditionally accepted chemical characteristics for good protein-adsorption resistance. It should be noted that this case is not unique. A few zwitterionic functional groups have also been identified as being protein-resistant (S. Chen, 2006; Chen, 2005; Sun, 2006).

As mentioned earlier in this discussion, surface and underlayer/substrate environment are only two of many aspects that can affect overall protein adsorption. Exposure conditions can also affect adsorption. In most membrane applications, the membrane is exposed to a protein solution that flows through the membrane through a pressure gradient. Consequently, it is important to test these functionalized membrane coatings under more realistic operating conditions to see if they are sufficiently protein-resistant under more real-world usage conditions.

### Aqueous Protein Fouling Studies Under Dynamic Flow Conditions

Protein fouling experiments under flow conditions (i.e., dead-end flow and filtration through the membrane) were performed on the functional polymer coatings that showed the most promise from prior SAM studies and the static protein exposure studies performed above. Specifically, polymers containing two of the most protein-resistant functional groups identified by prior SAM studies (i.e., piperazine, and azo-crown ether), and several of the new phosphonium and ammonium groups were tested under flow conditions and compared to uncoated PSf and a poly(1b)-coated membrane as reference and benchmark materials, respectively. The dynamic flow protein exposure experiments were conducted at the University of Texas at Austin with the same PSf membrane substrates used in the previous static exposure experiments. In the dynamic flow studies, PSf membranes coated with the functionalized polymers were prepared by spray-coating a 2 wt % solution of the monomer in methanol with a given amount of photo-initiator (no added cross-linker). The solvent was allowed to evaporate, and the thin monomer coating was then photopolymerized using a 351 nm UV lamp for 5 min under a nitrogen atmosphere at ambient temperature. This process was repeated once more to ensure pin-hole-free thin film coatings on the PSf membrane. The resulting films were not crosslinked, but were integrated, stable, and mechanically strong. The poly(1b)-coated membranes were made with a mixture of PEGDA, PEG (Mₙ=1,000,000) and water in a process described in the literature (X. Chen, 2006).

These studies were performed using 76-mm I.D. dead-end filtration cells with magnetic stirring was used to minimize concentration polarization. Desionized water was initially filtered through membrane samples with a differential transmembrane pressure of 3.4 bar for 0.5 h to compact the membranes and achieve an initial steady state permeance (Pₒ). A 1 g/L BSA in PBS solution was then filtered through the membranes for 2 h at 2.1 bar, and the final permeance during protein filtration (P₂) was noted as well as the initial rejection (Rₒ) of protein through the membranes. Rejection of protein was determined by UV-visible analysis of the permeate (Nakanishi, 2006). The membranes were then rinsed with deionized water to remove any remaining protein solution. Deionized water was again filtered through the same membranes at 3.4 bar, and the final steady state membrane permeance (P_{f}) was noted. In these dynamic membrane fouling studies, the relative permeance during and after the filtration of protein (i.e., P₂/Pₒ and P_{f}/Pₒ respectively) was used to ascertain the membranes' resistance to protein adsorption. Specifically, the quantity (P₂/Pₒ) represents the relative permeance while the membrane is exposed to proteins. The quantity (P_{f}/Pₒ) represents the relative permeance recovered after the protein-exposed membrane is re-exposed to a pure water feed.

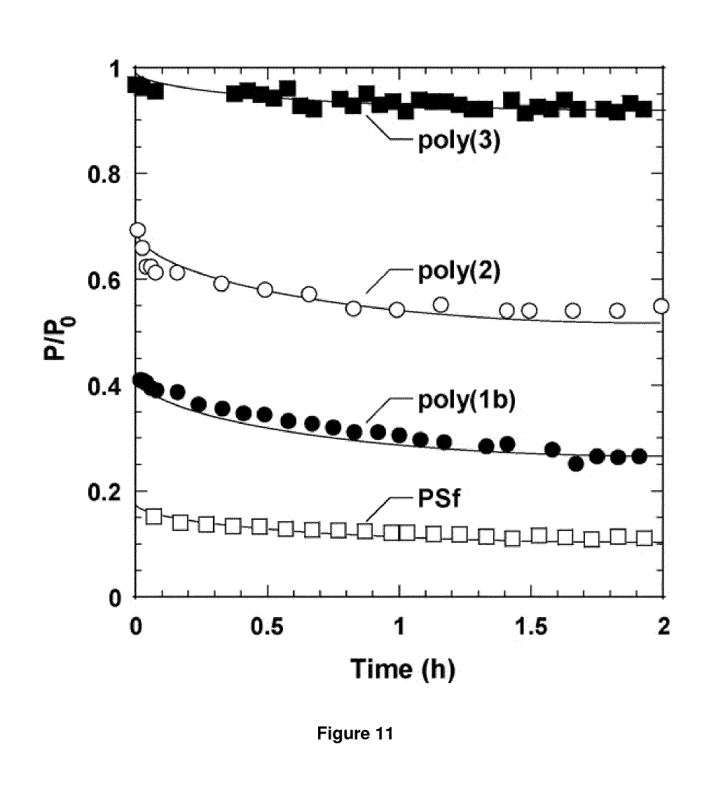

Table 1 shows the results of these dead-end protein filtration studies for uncoated PSf, and PSf membranes coated with poly(1b), poly(2), and poly(3), in order to compare the protein-resistance properties under dynamic flow of two functional groups (i.e., piperazine, and azo-crown ether) previously identified as having good-protein resistance in prior SAM studies (Ostuni, 2001). The relative permeance performance of these samples is plotted against time in FIG. 11. As can be seen in Table 1 and FIG. 11, the PEG-based poly(1b)-coating significantly reduced protein fouling compared to the uncoated PSf membrane. While the relative permeance of the poly(1b)-coated membrane is higher than uncoated PSf, its absolute permeance during and after protein exposure (P₂ and P_{f}, respectively) are still below that of the uncoated PSf membrane. PEG-based coatings (e.g., poly(1b)) are usually considered very protein-resistant in most membrane protein-fouling studies; however, there is clearly room for improvement.

It should be noted that both the poly(2) and poly(3) coatings are significantly more resistant to BSA fouling than the PEG-based poly(1b) coating. As can be seen in FIG. 11 and Table 1, the relative permeance drop for the piperazine-based poly(2)-coated sample was only half as much as that for the PEG-based poly(1b)-coated sample. The azo-crown-ether-based poly(3)-coated sample had almost no drop in permeance, suggesting that it is almost completely inert to protein-fouling under dynamic flow conditions. These results differ greatly from the results obtained in the static protein exposure experiments described earlier and prior studies done by others with analogous functionalized SAMs (Ostuni, 2003). The static protein exposure study in the first part of this example suggests that poly(2) should be the better candidate, whereas prior SAM studies suggest that poly(1b) should be better. Clearly, conditions other than surface functional group chemistry, such as the exposure/test conditions (i.e., static vs. dynamic flow) and surface environment (amorphous polymer vs. ordered SAM surface), can have a large effect on protein adsorption. It should be noted that while poly(2) and poly(3) appear to have excellent resistance to protein fouling as measured by P₂/P₀ and P_{f}/P₀, their absolute transport properties are on par, and significantly worse than the protein-fouled PSf membrane, respectively.

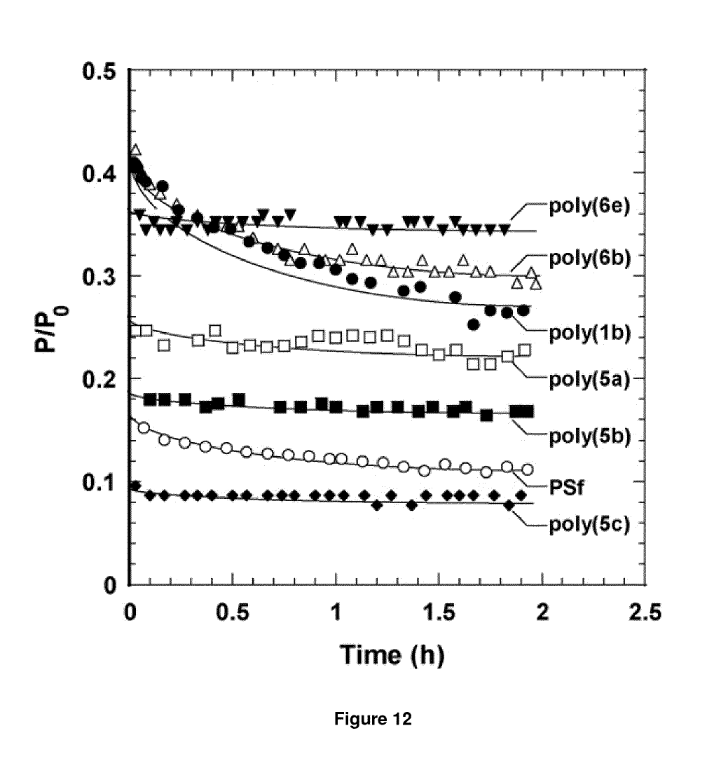

Table 2 and FIG. 12 show the absolute and relative permeance and protein rejection results of the dead-end protein filtration studies for the ammonium- and phosphonium-based polymer coatings. Several trends are observed for these data. First, under dynamic fouling conditions, the relative permeance of the poly(5a)-coated membrane (R=—CH₃, X=Br⁻) was much higher than the analogous poly(5b)-coated sample (R=−CH₃, X=Cl⁻), suggesting that the counter-ion plays a significant role in the protein resistance of these polymers. However, increasing the alkyl chain length from a methyl to an n-propyl side-group on the phosphonium polymers (i.e., poly(5b) to poly(5c)) decreases the relative permeance, suggesting that shorter organic substituents afford more protein resistance. The relative permeance of the ammonium-based poly(6b) (R=propyl, X=Cl⁻) coating is much higher than its phosphonium analogue poly(5c) (R=propyl, X=Cl⁻). This result suggests that ammonium-based polymers are superior to their phosphonium counterparts in resisting protein adsorption, all else being equal. Also, changing from alkyl substituents on the ammonium-based polymer to a more hydrophilic 2-(methoxylethoxyl)ethyl substituent (i.e., changing from poly(6b) to poly(6e)) increases the relative permeance.

It can also be seen from Table 2 and FIG. 12 that the relative permeances of the membranes coated with poly(5a), poly(6b), and poly(6e) are similar to or slightly better than the sample coated with PEG-based poly(1b). Despite less fouling, (as exemplified by its P₂/P₀ and P_{f}/P₀ values), the absolute permeances of poly (6b) and poly(6c) are less than that of an easily fouled, uncoated PSf membrane. Modifications to the coating techniques may be able to improve the absolute transport properties of these membrane coatings without significantly affecting protein resistance. The protein-adsorption-resistance of phosphonium-based poly(5a) under dynamic fouling conditions (as exemplified by its P₂/Pₒ and P_{f}/Pₒ values) is only modestly better than that of PEG-based poly(1b) at best. However, the absolute membrane transport properties of poly(5a) during protein filtration, its permeance (P₂), and its rejection (Rₒ) are all far superior to PEG-based poly(1b). The superior transport properties and resistance to protein adsorption of poly(5a) make it a candidate for a variety of membrane filtration applications. This result shows that polymers with quaternary “-onium” groups have the potential to be effective protein-resistant polymer coatings for water filtration membranes that may rival the performance of PEG-based coatings.

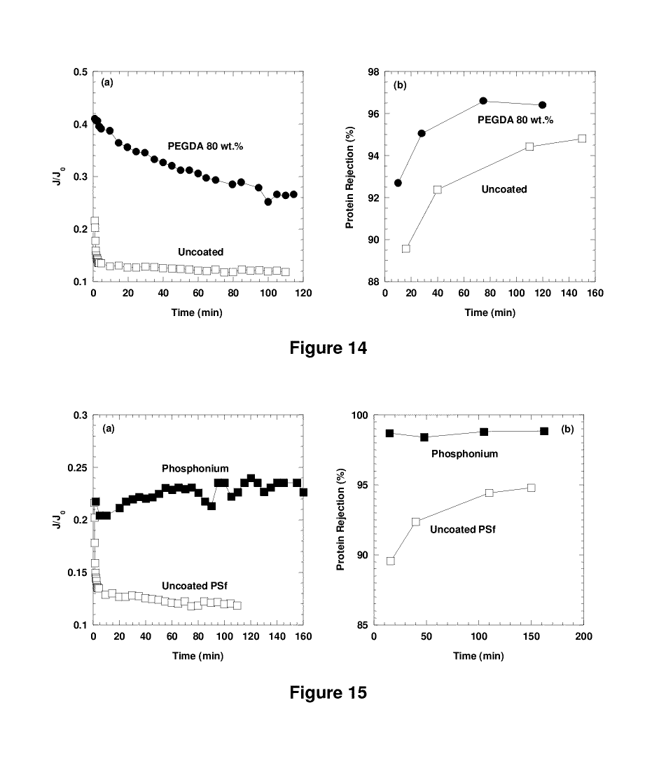

FIG. 14 shows performance of uncoated PSf vs. cross-linked 80 wt. % PEGDA (n=14)-coated PSf membrane in dead-end BSA (1 g/L) filtration studies: (a) relative flux change (J/J₀) as a function of time; and (b) percent protein rejection as a function of time.

FIG. 15 shows performance of poly(styrenemethylenetrimethylphosphonium bromide)-coated PSf membrane vs. uncoated PSf in dead-end BSA (1 g/L) flow studies (a) relative water flux as a function of time; and (b) percent protein rejection as a function of time.

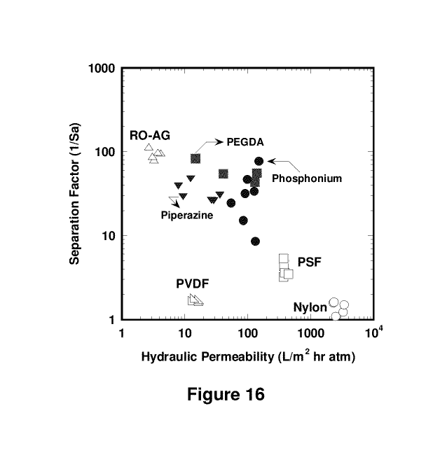

FIG. 16 shows a selectivity vs. permeability plot for PSf composite membranes prepared with monomers developed in this research program and other commercial membranes. BSA was used as the model protein

Effect of Nanostructure on Aqueous Protein Adsorption Under Static Exposure conditions

As described earlier, protein adsorption performance differs between surfaces coated with functionalized SAMs and analogous amorphous polymers. Prior SAM studies have suggested the nanoscale ordering of SAMs can greatly affects their resistance to protein adsorption (Vanderah, 2004; Harder, 1998). Also, prior work on inorganic surfaces have shown that protein adsorption behavior is affected by the presence of regular nanoscale surface features (Galli, 2001; Galli, 2002). Consequently, it is possible that nanostructured polymer coatings may afford enhanced protein adsorption resistant properties compared to their amorphous analogues.

In order to test this hypothesis, a cross-linkable lyotropic (i.e., amphiphilic) liquid crystal (LLC) monomer (i.e., ordered surfactant) (7) was used to form a nanostructured polymer analogue to 5a (Zhou, 2007). By way of a general background, LLCs can self-assemble into ordered nanostructured composite materials when mixed with a specific amount of solvent at a given range of temperatures. A mixture of the LLC monomer 7, water, and photo-initiator were pressed into a hydrophilic, ultra-high-molecular-weight, polyethylene fiber matte support (Solupor E075-9H01A), and photo-cross-linked at 70° C. with 365 nm light to produce a membrane with an ordered Q_{I} phase nanostructure (Zhou, 2007). This type of supported LLC membrane has been shown to have a uniform 0.75 nm nanopore network and can perform water desalination via size-exclusion (Zhou, 2007). It presents the same type of quaternary phosphonium group as poly(5a) but in a periodic, nanostructured format (FIG. 5a). The only caveat with this nanostructured water purification membrane is that it has only been formed as a pressed film onto Solupor E075-9H01A support (Zhou, 2007).

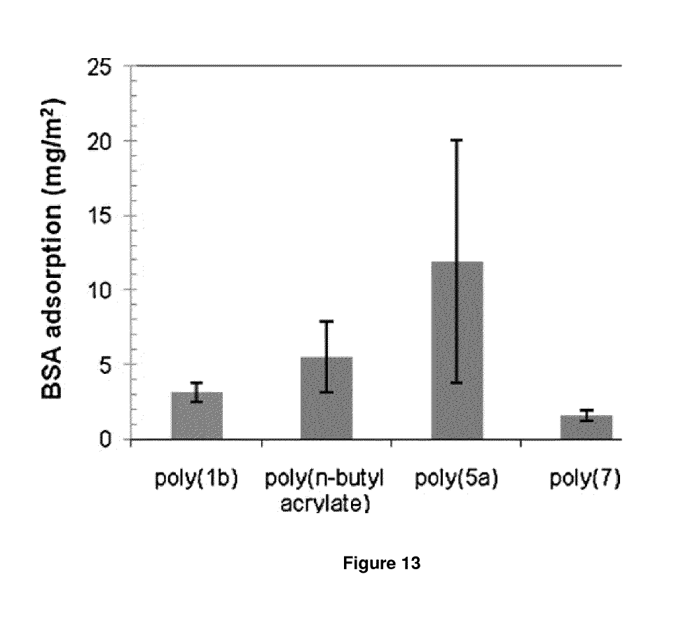

Preliminary static protein exposure experiments were conducted on the membrane coated with the nanostructured poly(7). FIG. 13 shows a comparison of the static exposure BSA adsorption levels of poly(1b), poly(n-butyl acrylate), poly(5a), and nanostructured poly(7) all hot-pressed and photo-cross-linked through Solupor E075-9H01A fiber matte support. As can be seen in FIG. 13, the static protein adsorption on the poly(7)-coated sample is significantly lower than its amorphous quaternary phosphonium analogue poly(5a) when the two coatings are similarly presented on the same support material. Nanostructured polymer poly(7) also adsorbs less than half the protein that PEG-based poly(1b) and poly(n-butyl acrylate) (a hydrophobic control coating) adsorb when processed and presented on the same Solupor E075-9H01A support. Although similar static exposure studies with Fg and flow studies remain to be done, this result is strong preliminary evidence that the presence of a regular nanostructure in polymer coatings may enhance protein adsorption resistance. Unfortunately, it was not possible to measure the static BSA adsorption level of uncoated Solupor E075-9H01A as a baseline reference. This fiber matte film is too porous and hydrophilic to allow protein solution to contact the surface in our testing configuration without the solution flowing through the material.

An interesting side effect of substituting the hydrophilic Solupor polyethylene fiber matte support for the original PSf support in this last study is that the ability of both poly(1b) and poly(5a) to resist protein adsorption is greatly reduced when these polymers are coated on Solupor E075-9H01A. A quick comparison of data from FIGS. 8a and 13 shows that the static exposure BSA adsorption level for poly(1b) approximately doubles when the coating is applied on Solupor E075-9H01A compared to PSf UF membrane support. Similarly, the static exposure BSA adsorption level for poly(5a) increases by about a factor of four when the polymer is on Solupor E075-9H01A compared to PSf support. This observation once again reinforces what was observed previously in this paper: Changing the nature of the underlying support material can make a significant difference in a coating material's effectiveness in resisting nonspecific protein adsorption, even when the same chemical functional groups are present on the surface.

TABLE 1
Dynamic Membrane Fouling Behavior of Polymer-coated PSf
Membranes Containing Functional Groups Identified in Prior
SAM Studies: Absolute Permeance, Relative Permeance, and
Protein Rejection Data.

| | P₀ | P₂ | P_{f} | | | |
|---|---|---|---|---|---|---|
| | (L m⁻² h⁻¹ | (L m⁻² h⁻¹ | (L m⁻² h⁻¹ | | | R₀ |
| Sample | bar⁻¹) | bar⁻¹) | bar⁻¹) | P₂/P₀ | P_{f}/P₀ | (%) |
| PSf | 257 | 29 | 45 | 11 | 18 | 87.8 |
| poly(1b) | 63 | 17 | 29 | 27 | 46 | 92.7 |
| poly(2) | 59 | 32 | 48 | 54 | 81 | 96.2 |
| poly(3) | 11.7 | 10.8 | 11.2 | 92 | 96 | 96.6 |

TABLE 2
Dynamic BSA Fouling of Phosphonium- and Ammonium-based
Polymer-coated PSf Membranes: Absolute Permeance, Relative
Permeance, and Protein Rejection Data.

| | P₀ | P₂ | P_{f} | | | |
|---|---|---|---|---|---|---|
| | (L m⁻² h⁻¹ | (L m⁻² h⁻¹ | (L m⁻² h⁻¹ | | | R₀ |
| Sample | bar⁻¹) | bar⁻¹) | bar⁻¹) | P₂/P₀ | P_{f}/P₀ | (%) |
| PSf | 257 | 29 | 45 | 11 | 18 | 87.8 |
| poly(1b) | 63 | 17 | 29 | 27 | 46 | 92.7 |
| poly(5a) | 145 | 33 | 79 | 23 | 54 | 98.0 |
| poly(5b) | 90 | 15 | 15 | 17 | 17 | 89.1 |
| poly(5c) | 35 | 3 | 2.2 | 8.6 | 6 | 90.2 |
| poly(6b) | 62 | 18 | 22 | 29 | 35 | 93.6 |
| poly(6e) | 45 | 16 | 19 | 36 | 42 | 87.9 |

### CONCLUSION

Some simple quaternary phosphonium and ammonium-based polymer coatings have been shown to effectively resist the adsorption of proteins (i.e. BSA and Fg) from aqueous solution under static exposure and dynamic membrane fouling conditions. In some cases, their protein resistance performance is as good as, or better than, PEG-based polymers and polymer analogues of some of the best organic groups identified in prior functionalized SAM-based protein resistance studies. In particular, initial results of a cross-linked quaternary phosphonium-based polystyrene polymer, polymer (5a) has exceptional protein-fouling resistance and better water transport properties than PEG-based polymer coatings.

In addition to surface chemistry, it was also found that small changes in surface environment (i.e. amorphous polymer vs. ordered SAM surfaces) and exposure conditions (i.e. static adsorption vs. dynamic filtration testing) can greatly affect overall protein adsorption behavior. While SAMS-based polymer, poly(2) has excellent protein resistance, it was found that polymers containing the same functional groups as identified as highly protein-resistant in prior SAM experiments were not nearly as protein resistant when presented as amorphous polymer coatings on porous membranes under static protein exposure conditions. From these results, it is believed that the underlying highly ordered alkyl chain conformations and near atomic surface smoothness observed in SAMS may have as large an effect on protein adsorption resistance as the type of chemical functionality presented at the surface. In light of the present results, it appears that studies with ideal SAM systems unfortunately may not accurately predict the best protein-resistant chemistries under realistic operation conditions, especially with porous polymer membrane substrates. Differences in protein adsorption resistance performance were also observed between dynamic flow membrane foundling experiments and static exposure studies. Polymer coatings with the same functional groups identified as highly protein resistance in prior SAM-based studies (e.g. poly(2) and poly(3)), were much more protein resistance under dynamic flow fouling conditions than under static protein exposure conditions. Differences were also seen for the phosphonium- and ammonium-based polymers. Unlike the static adsorption experiments, the type of organic groups, and the nature of the counter ions of the ammonium and phosphonium polymers all had a significant effect on observed protein adsorption.

Finally, preliminary studies show that poly(7), a nanostructured lyotropic LC polymer analogue of poly(5a) containing the same type of tetra(alky)phosphonium bromide group, has enhanced protein resistance under static exposure conditions. It is possible that it has a similar ordered surface environment similar to a periodic SAM array, allowing it to have enhanced protein resistance. Since regular nanometer-size surface features on inorganic surfaces have recently been found to affect static protein adsorption, the use of a nanostructured, periodic, polymer surface may also lead to improved performance in this are.

Additional information may be found in Hatekeyama et al., 2009, J. Membr. Sci, 330, 104-116 and the supporting information therefore which is hereby incorporated by reference.

### REFERENCES

Akelah, A.; Rehab, A.; Agag, T.; Betiha, M. J. Appl. Polym. Sci. 2007, 103, 3739.
Al-Ahmad, M.; Aleem, F. A. A.; Mutiri, A.; Ubaisy, A. Desalination 2000, 132.
Al-Amoudi, A.; Lovitt, R. W. J. Membr. Sci. 2007, 303, 4.
Ang, W. S.; Lee, S.; Elimelech, M. J. Membr. Sci. 2006, 272, 198.
Arkhangelsky, E.; Kuzmenko, D.; Gitis, V. J. Membr. Sci. 2007, 305, 176.
Baccante, A.; Quaresima, R.; Volpe, R.; Tapparo, A.; Corain, B. Chimica e I'Industria 1997, 79 (9), 1233.
Balomajumder, C.; Sagar, V. V. Chem. Eng. World 2003, 38, 43.
Basalyga, D. M.; Latour, R. A., Jr. J. Biomed. Mater. Res. 2003, 64A, 120.
Belfort, G.; Davis, R. H.; Zydney, A. L. J. Membr. Sci. 1994, 96, 1
Blummel, J.; Perschmann, N.; Aydin, D.; Drinjakovic, J.; Surrey, T.; Lopez
Garcia, M.; Kessler, H.; Spatz, J. P. Biomater. 2007, 28, 4739
Bouhabila, E. H.; Aim, R. B.; Buisson, H. Sep. Purif. Tech. 2001, 22-23, 123.
Branch, D. W.; Wheeler, B. C.; Brewer, G. J.; Leckband, D. E. Biomater. 2001, 2001, 1035.
Chapman, R. G.; Ostuni, E.; Takayama, S.; Holmlin, R. E.; Yan, L.; Whitesides, G. M. J. Am. Chem. Soc. 2000, 122, 8303.
Chen, C. S.; Mrksich, M.; Huang, S.; Whitesides, G. M.; lngber, D. E. Science 1997, 276, 1425.
Chen, S.; Liu, L.; Jiang, S. Langmuir 2006, 22.
Chen, S.; Zheng, J.; Li, L.; Jiang, S. J. Am. Chem. Soc. 2005, 127, 14473.
Chen, W.-L.; Shull, K. R. In Polymer Surfaces and Interfaces III; Richards, R. W.; Peace, S. K.; Eds.; Wiley: Chichester, 1999; pp. 269-283.
Chen, X.; Jianhua, W. Talanta 2006, 69, 681.
Chen, Y.; Kang, E. T.; Neoh, K. G.; Wang, P.; Tan, K. L. Synth. Metals 2000, 110, 47.
Chollangi, A.; Hossain, M. M. Chem. Engin. Processing 2007, 46, 398.
Crouzet, C.; Decker, C.; Marchal, J. Makromol. Chem. 1976, 177, 145.
Deible, C. R.; Petrosko, P.; Johnson, P. C.; Beckman, E. J.; Russell, A. J.; Wagner, W. R. Biomater. 1998, 19, 1885.
Fane, A. G.; Fell, C. J. D.; Waters, A. G. J. Membr. Sci. 1983, 16, 211.
Fang, F.; Satulovsky, J.; Szleifer, I. Biophys. J. 2005, 89, 1516.
Feldman, K.; Hahner, G.; Spencer, N. D.; Harder, P.; Grunze, M. J. Am. Chem. Soc. 1999, 121, 10134.
Fleming, J. C. International Patent Application WO/00/63025, 2000.
Fu, K.; Klibanov, A. M.; Langer, R. Nature Biotechnol. 2000, 18, 24.
Galli, C.; Coen, M. C.; Hauert, R.; Katanaev, V. L.; P., W. M.; Groning, P.; Schlapbach, L. Surf. Sci. 2001, 474, L180.
Galli, C.; Coen, M. C.; Hauert, R.; Katanaev, V. L.; Groning, P.; Schlapbach, L. Colloids Surf. B: Biointerfac. 2002, 26, 255.
Gander, M.; Jefferson, B.; Judd, S. Sep. Purif. Technol. 2000, 18, 119.
Garmin, H.; Warnez, M. Y. Singapore Patent Application A1 200550928, 2005
Gerhardt, W. Martens, C. Z. Chem. 1985, 25, 143.
Gifford, R.; Kehoe, J. J.; Barnes, S. L.; Kornilayev, B. A.; Alternan, M. A.; Wilson, G. S. Biomater. 2006, 27, 2587.
Gordon, A. J.; Ford, R. A. The Chemist's Companion: A Handbook of Practical Data, Techniques, and References; John Wiley & Sons: New York, 1973.
Hamburger, R.; Azaz, E.; Donbrow, M. Pharm. Acta Hely. 1975, 50, 10.
Harder, P.; Grunze, M.; Dahint, R.; Whitesides, G. M.; Laibinis, P. E. J. Phys. Chem. B 1998, 102, 426.
Harris, J. M.; Zalipsky, S. Poly(ethylene glycol): Chemistry and Biological Applications; American Chemical Society: Washington, D.C., 1997.
Herold, D. A.; Keil, K.; Bruns, D. E. Biochem. Pharm. 1989, 38, 73.
Jenney, C. R.; Anderson, J. M. J. Biomed. Mater. Res. 1999, 44, 206.
Ju, H.; McCloskey, B. D.; Sagle, A. C.; Wu, Y.-H.; Kusuma, V. A.; Freeman, B. D. J. Membr. Sci. 2008, 307, 260.
Kanazawa, A.; Ikeda, T.; Endo, T. J. Appl. Polym. Sci. 1994, 53 (9), 1245.
Kanazawa, A.; Ikeda, T.; Endo, T. J. Appl. Polym. Sci. 1994, 52 (5), 641.
Kanazawa, A.; Ikeda, T.; Endo, T. J. Polym. Sci. A: Polym. Chem. 1993c, 31 (12), 3031.
Kanazawa, T.; Ikeda, T.; Endo, T. J. Polym. Sci. A: Polym. Chem. 1993b, 31, 1441.
Kanazawa, A.; Ikeda, T.; Endo, T. J. Polym. Sci. A: Polym. Chem. 1993a, 31 (2), 335.
Kane, R. S.; Deschatelets, P.; Whitesides, G. M. Langmuir 2003, 19, 2388.
Kang, S.; Asatekin, A.; Mayes, A. M.; Elimelech, M. J. Membr. Sci. 2007, 296, 42.
Kang et al., 2008, J. Membr. Sci, 318, 227-232.
Kawai, F. Appl. Microbiol. Biotechnol. 2002, 58, 30.
Kenawy, E.-R.; Abdel-Hay, F. I.; Abou EI-Magd, A.; Mahmoud, M. React. Funct. Polym. 2006a, 66 (4), 419.
Kenawy, E.-R.; Abdel-Hay, F. I.; Shashada, L.; Abou El-Racheem, A.; El-Shanshoury, R; El-Newehy, M. H. J. Appl. Polym. Sci. 2006b, 102 (5), 4780.
Kenawy, E.-R.; Abdel-Hay, F. I.; EI-Shanshoury, R; Abd El-Racheem, R.; El-Newehy, M. H. J. Controlled Rel. 1998, 50 (1-3), 145.
Koehler, J. A.; Ulbricht, M.; Belfort, G. Langmuir 1997, 13, 4162.
Kristiansen, S. PCT International Application WO 2006002628 A1 200601112, 2006.
Lewis, A. L. Colloids Surf B: Biointerfaces 2000, 18 (3,4), 261.
Liu, F.; Du, C.-H.; Zhu, B.-K.; Xu, Y.-Y. Polymer 2007, 48, 2910.
Linder, E. Biofouling 1992, 6 (2), 193.
Linder, E. in Recent Dev. Biofouling Control; Thompson, M.-F.; ed.; Balkema: Rotterdam, 1994; pp. 305-311.
Luk, T.-T.; Kato, M.; Mrksich, M. Langmuir 2000, 16, 9604.
Ma et al., Macromolecules, 2000, 33, 331-335.
Macbeath, G.; Schreiber, S. L. Science 2000, 289, 1760.
Manz, A.; Becker, H. Microsystem Technology in Chemistry and Life Sciences; Springer-Verlag: Berlin, Germany, 1998.
Marrot, B.; Barrios-Martinez, A.; Moulin, P.; Roche, N. Env. Prog. 2004, 23, 59.
Marshall, A. D.; Munro, P. A.; Tragardh, G. Desalination 1993, 91, 65.
McPherson, T.; Kidane, A.; Szleifer, I.; Park, K. Langmuir 1998, 14, 176.
Mehta, A.; Zydney, A. L. J. Membr. Sci. 2005, 249, 245
Mrksich, M.; Sigal, G. B.; Whitesides, G. M. Langmuir 1995, 11, 4383.
Nabe, A.; Staude, E.; Belfort, G. J. Membr. Sci. 1997, 133, 57.
Nakanishi, K.; Sakiyama, T.; Imamura, K. J. Biosci. Bioengin. 2001, 91, 233.
Nakanishi, K.; Matsumoto, K. J. Membr. Sci. 2006, 285, 126.
Niklason, L. E.; Gao, J.; Abbott, W. M.; Hirschi, K. K.; Houser, S.; Marini, R.; Langer, R. Science 1999, 284, 489.
Nilsson, J. L. J. Membr. Sci. 1990, 52, 121.
Nishikubo, T.; Abe, K.; Uchida, J. Makromol. Chem. 1989, 190 (6), 1471.
Ognier, S.; Wisniewski, C.; Grasmick, A. J. Membr. Sci. 2002, 209, 27.
Okochi, M.; Nakamura, N.; Matsunaga, T. Denki Kagaku oyobi Kogyo Butsuri Kagaku 1995, 63 (12), 1200.
Ostuni, E.; Chapman, R. G.; Holmlin, R. E.; Takayama, S.; Whitesides, G. M. Langmuir 2001, 17, 5605.
Ostuni, E.; Grzybowski, B. A.; Mrksich, M.; Roberts, C. S.; Whitesides, G. M. Langmuir 2003, 19, 1861.
Parnham, C. S.; Davis, R. H. J. Membr. Sci. 1996, 118, 259.
Pazatos, A.; Ong, Y.-L.; Boulay, F.; Elbert, D. L.; Hubbell, J. A.; Sharma, M. M.; Georgiou, G. Langmuir 2000, 16, 9155.
Pindzola, B. A.; Jin, J.; Gin, D. L. J. Am. Chem. Soc. 2003, 125, 2940.
Popa, A.; Ilia, G.; Ilescu, S.; Dehelean, G.; Pascariu, A.; Bora, A.; Davidescu, C. M. Mol. Cryst. Liq. Cryst. 2004, 418, 195.
Popa, A.; Davidescu, C. M.; Trif, R.; Iliescu, S.; Ilia, G.; Dehelean, G. Rev. Roumaine Chim. 2003a, 48 (6), 485.
Popa, A.; Davidescu, C. M.; Trif, R.; Ilia, G.; Iliescu, S.; Dehelean, G. React. Funct. Polym. 2003b, 55(2), 485.
Popa, A.; Davidescu, C. M.; Iliescu, S.; Ilia, G.; Dehelean, G.; Macarie, L.; Trif, R. Chin. J. React. Polym. 2000, 9 (2), 118.
Popa, A.; Davidescu, C. M.; Iliescu, S.; Ilia, G.; Dehelean, G.; Macarie, L.; Trif, R. Roumanian Chem. Quart. Rev. 2001, 8 (3-4), 275.
Price, C. International Patent Application WO/2005/075581, 2005.
Ratner, B. D.; Hoffmann, F. J.; Schoen, J. E.; Lemons, F. Biomaterials Science. An Introduction to Materials in Medicine; Academic Press: New York, 1996.
Russell, A. J.; Koepsel, R.; Lee, S. B.; Matyjaszewski, K. U.S. Patent Application US 2006008490 A1 20060112, 2006.
Santini, J. T.; Cima, M. J.; Langer, R. Nature 1999, 397, 335.
Schroeder, J. D.; Scales, J. C. U.S. Patent Application US 2002051754 A1 20020502, 2002.
Sethuraman, A.; Han, M.; Kane, R. S.; Belfort, G. Langmuir 2004, 20, 7779.
Sofia, A.; Ng, W. J.; Ong, S. L. Desalination 2004, 160, 67.
Sogawa, K.; Takahashi, K. J. Biochem. 1978, 83, 1783.
Stamatialis, D. F.; Papenburg, B. J.; Girones, M.; Saiful, S.; Bettahalli, S. N. M.; Schmitmeier, S.; Wessling, M. J. Membr. Sci. 2008, 308, 1.
Sun, Q.; Su, Y.; Ma, X.; Wang, Y.; Jiang, Z. J. Membr. Sci. 2006, 285, 299.
Talarico, T.; Swank, A.; Privalle, C. Biochem. Biophys. Res. Commun. 1998, 250, 354.
Taniguchi et al., J. Membr. Sci., 231, 2004, 147-157.
Tzannis, S. T.; Hrushesky, W. J. M.; Wood, P. A.; Przybycien, T. M. J. Colloid Interfac. Sci. 1997, 189, 216.
Udenfreind, S.; Stein, S.; Bohlen, P.; Dairman, W.; Leimgruber, W.; Weigele, M. Science 1972, 178 (4063), 871.
Vanderah, D. J.; La, H.; Naff, J.; Silin, V.; Rubinson, K. A. J. Am. Chem. Soc. 2004, 126, 13639.
van Reis, R.; Zydney, A. J. Membr. Sci. 2007, 297, 16.
Whitney, M.; Rockenstein, E.; Cantin, G.; Knapp, T.; Zlokarnik, G.; Sanders, P.; Durick, K.; Craig, F. F.; Negulescu, P. A. Nat. Biotechnol. 1998, 16, 1329.
Worley, S. D.; Eknoian, M.; Bickert, J.; Williams, J. F. In Polymeric Drug and Drug Delivery Systems; Ottenbrite, R. M.; Kim, S.-W., eds.; Technomic: Lancaster, Pa., 2001; pp. 231-238.
Youngblood, J. P.; Andruzzi, L.; Ober, C. K.; Hexemer, A.; Kramer, E. J.; Callow, J. A.; Finlay, J. A.; Callow, M. E. Biofouling 2003, 19, 91.
Zarras, P.; Vogl, O. J. Macromol. Sci., Pure Appl. Chem. 2000, A37, 817.
Zhao, Y.-H.; Zhu, B.-K.; Kong, L.; Xu, Y.-Y. Langmuir 2007, 23, 5779.
Zhou, M.; Nemade, P. R.; Lu, X.; Zeng, X.; Hatakeyama, E. S.; Noble, R. D.; Gin, D. L. J. Am. Chem. Soc. 2007, 129, 9574.
Zydney, A. L. Int. Dairy J. 1998, 8, 243.

We claim:

1. A composite membrane comprising:
a) a support membrane selected from the group consisting of microfiltration membranes, ultrafiltration membranes, nanofiltration membranes and reverse osmosis membranes; and
b) a dense polymer layer attached to at least a portion of the outer surface of said support, wherein the polymer layer comprises surface quaternary phosphonium or ammonium functional groups;
wherein the composite membrane is permeable to aqueous solutions and the quaternary functional groups may be described by the formula 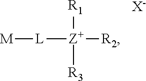
where Z is nitrogen or phosphorus, R₁, R₂ and R₃, independently from one another, are optionally substituted straight-chain or branched-chain hydrocarbons having 1-8 carbon atoms, X⁻ is an anion, and M is a structural repeating unit of the polymer layer.

2. The membrane of claim 1 wherein the polymeric layer is crosslinked.

3. The membrane of claim 1 wherein the polymeric layer is formed by polymerization of a monomer having the formula: 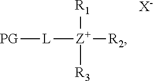
wherein PG is a polymerizable group,
L is a linking unit which is an alkyl group having from 1 to 8 carbon atoms or —(CH₂ CH₂O)ₙ—CH₂CH₂— where n is from 1 to 4,
Z is nitrogen or phosphorus,
R₁, R₂ and R₃, independently from one another, are optionally substituted straight-chain or branched-chain hydrocarbons having 1-8 carbon atoms, and
X⁻ is an anion.

4. The membrane of claim 3 wherein the polymerizable group is selected from the group consisting of an acrylate group, a methacrylate group, a styrene group, a vinylether group, an acrylamide group, a methacrylamide group.

5. The membrane of claim 3 wherein R₁, R₂ and R₃, independently from one another, are selected from the group consisting of methyl, ethyl, propyl, isopropyl, n-butyl, t-butyl, isobutyl, pentyl, hexyl groups, —(CH₂)ₙ—OH where n is from 1 to 5, —(CH₂CH₂O)ₙ—CH₃ where n is 1 is from 2, —(CH₂CH₂O)ₙ—H where n is from 1 to 2.

6. The membrane of claim 3 where X is selected from the group consisting of Br⁻, I⁻, BF₄⁻, Cl⁻, Tf₂N⁻ and OAc⁻

7. The membrane of claim 1 wherein the thickness of the polymeric layer is between 0.01 μm and 10 μm.

8. The membrane of claim 1 wherein the support membrane is porous with a pore size between about 2.5 nm and about 120 nm.

9. The membrane of claim 8, wherein the composite membrane is permeable to a aqueous solution when a pressure difference of 2 MPa or less is applied across the membrane.

10. A method of purifying water, the method comprising the comprising the steps of:
a. bringing water containing impurities into contact with a first side of the composite membrane of claim 1, the first side of the membrane including the polymer layer;
b. applying a pressure difference across the membrane; and
c. withdrawing purified water from a second side of the membrane.

11. The method of claim 10 wherein the polymer layer is formed by polymerization of a monomer having the formula: 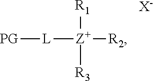
wherein PG is a polymerizable group,
L is a linking unit which is an alkyl group having from 1 to 8 carbon atoms or —(CH₂ CH₂O)ₙ—CH₂CH₂— where n is from 1 to 4,
Z is nitrogen or phosphorus,
R₁, R₂ and R₃, independently from one another, are optionally substituted straight-chain or branched-chain hydrocarbons having 1-8 carbon atoms, and
X⁻ is an anion.

12. The method of claim 10, wherein the thickness of the polymeric layer is between 0.01 μm and 10 μm.

13. The method of claim 12, wherein the support membrane is porous and the applied pressure drop is 2 MPa or less.

14. A method of making a composite membrane, the method comprising the steps of:
a. preparing a solution comprising a functionalized monomer having quaternary phosphonium or ammonium functional groups, an organic solvent for the monomer, a polymerization initiator and a cross-linking agent,
b. applying a layer of the solution onto a support membrane, the support membrane being selected from the group consisting of microfiltration membranes, ultrafiltration membranes, nanofiltration membranes and reverse osmosis membranes;
c. evaporating solvent from the solution; and
d. cross-linking the monomer.
wherein the organic solvent in the solution is selected to be compatible with the support membrane and the functionalized monomer has the formula: 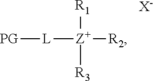
wherein PG is a polymerizable group,
L is a linking unit which is an alkyl group having from 1 to 8 carbon atoms or —(CH₂ CH₂O)ₙ—CH₂CH₂— where n is from 1 to 4,
Z is nitrogen or phosphorus,
R₁, R₂ and R₃, independently from one another, are optionally substituted straight-chain or branched-chain hydrocarbons having 1-8 carbon atoms, and
X⁻ is an anion.

15. The method of claim 14 wherein the polymerizable group is selected from the group consisting of an acrylate group, a methacrylate group, a styrene group, a vinylether group or an acrylamide group, and combinations thereof.

16. The method of claim 14 wherein R₁, R₂ and R₃, independently from one another, are selected from the group consisting of methyl, ethyl, propyl, isopropyl, n-butyl, t-butyl, isobutyl, pentyl, hexyl groups, —(CH₂)ₙ—OH where n is from 1 to 5, —(CH₂—CH₂O)ₙ—CH₃ where n is 1 is from 2, —(CH₂—CH₂O)ₙ—H where n is from 1 to 2, and combinations thereof.

17. The method of claim 14 where X is selected from the group consisting of Br⁻, BF₄⁻, Cl⁻, Tf₂N⁻ and OAc⁻
